(19) United States
(12) Patent Application Publication
(10) Pub. No.: US 2026/0304264 A1
(43) Pub. Date: Oct. 1, 2026

(54) TCI BEFORE AND AFTER CELL SWITCH COMMAND IN CANDIDATE CELL AND ACTIVATED TCI SELECTION FOR LTM

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/479,707

(22) PCT Filed: Jul. 6, 2023
(86) PCT No.: PCT/CN2023/106021

§ 371 Date: Oct. 28, 2025

(51) Int. Cl. H04W 36/08; H04B 7/06; H04W 36/00; H04W 36/04

(52) U.S. Cl. CPC H04W 36/08; H04B 7/06968; H04W 36/0061; H04W 36/008355; H04W 36/04

(57) ABSTRACT

Apparatuses and methods for TCI before and after a cell switch command in a candidate cell and activated TCI selection for LTM are described. An apparatus is configured to receive a second TCI state list associated with target cell UE mobility. The apparatus is configured to activate, after a serving cell to target cell switch, based on a state list indication, a first TCI state list associated with a target cell configuration at the UE and/or the second TCI state list. Another apparatus is configured to activate, before a serving cell to target cell switch, a first TCI state list associated with a serving cell configuration of the UE and/or a second TCI state list associated with a target cell configuration for UE mobility. The apparatus is configured to maintain, after the switch, based on a state list indication, at least the second TCI state list activated at the UE.

### TECHNICAL FIELD

The present disclosure relates generally to communication systems, and more particularly, to wireless communications systems and user equipment (UE) mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a network node, a second transmission configuration indication (TCI) state list associated with mobility of the UE for a target cell. The apparatus is also configured to activate, subsequent to a switch from a serving cell to the target cell and based on a state list indication, at least one of a first TCI state list associated with a cell configuration of the target cell at the UE or the second TCI state list.

In the aspects, the method includes receiving, from a network node, a second TCI state list associated with mobility of the UE for a target cell. The method also includes activating, subsequent to a switch from a serving cell to the target cell and based on a state list indication, at least one of a first TCI state list associated with a cell configuration of the target cell at the UE or the second TCI state list.

In an aspect of the disclosure, a method, a computer-readable medium, and an apparatus are provided. The apparatus is configured to activate, prior to a switch from a serving cell to a target cell, at least one of a first TCI state list associated with a first cell configuration of the serving cell of the UE or a second TCI state list associated with a second cell configuration of the target cell for mobility of the UE. The apparatus is also configured to maintain, subsequent to the switch from the serving cell to the target cell and based on a state list indication, at least the second TCI state list as activated at the UE.

In the aspects, the method includes activating, prior to a switch from a serving cell to a target cell, at least one of a first TCI state list associated with a first cell configuration of the serving cell of the UE or a second TCI state list associated with a second cell configuration of the target cell for mobility of the UE. The method also includes maintaining, subsequent to the switch from the serving cell to the target cell and based on a state list indication, at least the second TCI state list as activated at the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example configuration in UE mobility, in accordance with various aspects of the present disclosure.

FIG. 5 is a call flow diagram for wireless communications, in accordance with various aspects of the present disclosure.

FIG. 6 is a call flow diagram for wireless communications, in accordance with various aspects of the present disclosure.

FIG. 7 is a diagram illustrating examples for TCI configurations and activations in UE Layer-1/Layer-2 (L1/L2) triggered mobility (LTM), in accordance with various aspects of the present disclosure.

FIG. 8 is a diagram illustrating examples for TCI configurations and activations in UE LTM, in accordance with various aspects of the present disclosure.

FIG. 9 is a diagram illustrating an example for TCI configurations and activations in UE LTM, in accordance with various aspects of the present disclosure.

FIG. 10 is a diagram illustrating examples for TCI configurations and activations in UE LTM, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks, such as an LTE network and/or a 5G NR network, among other examples, may be designed to support UE mobility. For example, a wireless communication system may support LTM for UEs in which an associated cell for a UE may be updated using L1/L2 signaling from a network to a UE. The updates may be based on an L1 measurements (e.g., intra- and/or inter-frequency measurements). As an example, a UE may be initially served by one or more serving cells, which may include a special cell (SpCell) and/or one or more secondary cells (Cells), while candidate cells may be available to the UE for LTM. An SpCell may be a primary cell (PCell) or a primary secondary cell (PSCell). The UE may receive LTM communications from the serving cell for a move, using LTM, to a target cell, e.g., one of the candidate cells, as a new serving cell. The UE may then move to the target cell and initiate communications therewith (e.g., configurations for beams, a transmission configuration indication (TCI), a random access channel (RACH), etc.).

However, TCI state activation of a candidate and/or target cell may be received before the reception of a beam indication(s) of the candidate and/or target cell, in some scenarios, while the TCI state activation of a candidate and/or target cell may be received together with the reception of beam indication of the candidate and/or target cell, in other scenarios. These two scenarios may also both be supported based on the capability(ies) of the moving UE, which may entail various beam indication and/or TCI activation timing relationships. When TCI state lists are used before cell switching, the TCI state lists may be used before, or together with, the cell switch command, and such TCI state lists may be configured external to configurations of both source/serving cell and target/candidate cells. Yet, when TCI state lists are used after cell switching, the TCI state lists may be used after a cell switching command and can be configured inside the target/candidate cell configuration. Thus, the relationship between these two TCI state list scenarios may impose complexity and timing issues. Likewise, a UE may receive TCI activations for multiple serving/candidate cells at different time occasions, and/or a UE may receive TCI activations for candidate cells when the UE has already been activated with a TCI for a serving cell. If the total number of activated TCIs exceeds the UE capability, the UE may not be configured to efficiently handle such a case. Similarly, when multiple candidate cells have activated TCIs, but only a subset thereof becomes a target cell(s) by a cell switch command(s), the remaining, non-selected cells are still candidate cells, and the UE may not be configured to efficiently handle such a case.

Various aspects relate generally to inter-cell mobility of UEs. Some aspects more specifically relate to TCI before and after a cell switch command in a candidate cell and activated TCI selection for LTM. In some examples, TCI state lists may have TCIs activated, maintained, and/or deactivated based on UE capabilities, state list conditions against which the TCI state lists are evaluated, and/or state list indications provided from a network node (e.g., a serving cell) to a UE. In some examples, such activations, maintenance, and/or deactivations may be performed by a UE based on TCI state lists being received/utilized either with/before or after cell switching.

Particular aspects of the subject matter described in this disclosure can be implemented to realize one or more of the following potential advantages. In one example, by adaptively configuring a UE for TCI state lists before and after cell switching commands, the described techniques can be used to enable a UE to manage TCI state lists that are used before, or together with, cell switch commands where the TCI state lists are configured external to configurations of both source/serving cell and target/candidate cells, and that are used after cell switching commands where the TCI state lists are configured inside target/candidate cell configurations. In another example, by enabling a UE to perform down selection of activated TCIs, the described techniques can be used to receive TCI activations for multiple serving and candidate cells at different time occasions. In a further example, by configuring a UE to maintain or deactivate non-selected, candidate cell TCI activations after a target cell(s) is selected based on the UE capability, the described techniques can be used to enable a UE to support activated TCIs for the target cell(s).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

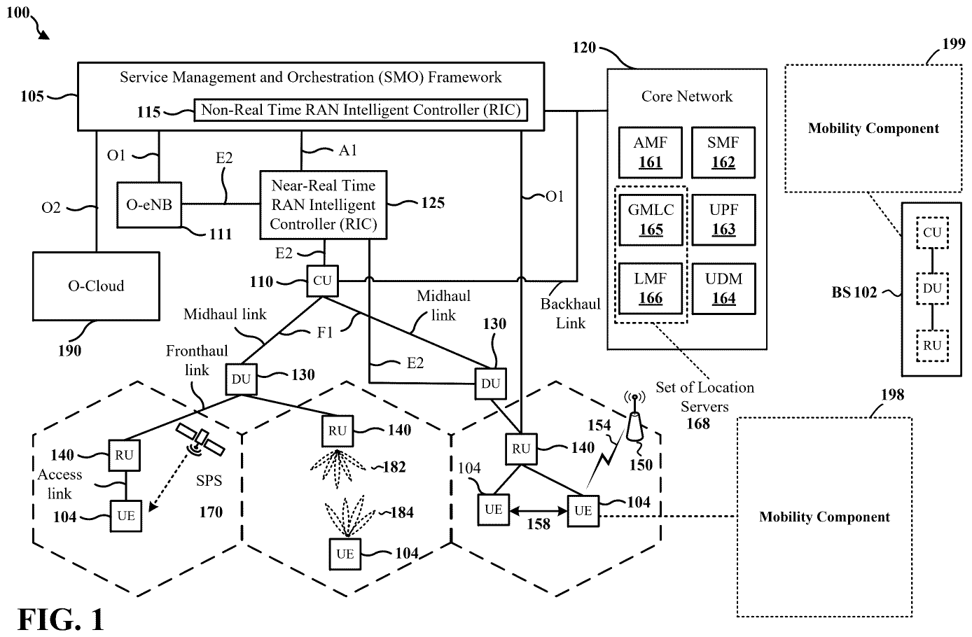

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a mobility component 198 (“component 198”) that may be configured to receive, from a network node, a second TCI state list associated with mobility of the UE for a target cell. The component 198 may also be configured to activate, subsequent to a switch from a serving cell to the target cell and based on a state list indication, at least one of a first TCI state list associated with a cell configuration of the target cell at the UE or the second TCI state list. The component 198 may be configured to maintain, subsequent to the switch from the serving cell to the target cell and based on the state list indication, the first TCI state list and the second TCI state list. The component 198, to receive the second TCI state list, may be configured to receive a third TCI state list associated with a candidate cell configuration that is separate from the cell configuration of the target cell, and may be configured to maintain or deactivate, subsequent to the switch from the serving cell to the target cell and based on the state list indication, the third TCI state list. In certain aspects, the component 198 may be configured to activate, prior to a switch from a serving cell to a target cell, at least one of a first TCI state list associated with a first cell configuration of the serving cell of the UE or a second TCI state list associated with a second cell configuration of the target cell for mobility of the UE. The component 198 may also be configured to maintain, subsequent to the switch from the serving cell to the target cell and based on a state list indication, at least the second TCI state list as activated at the UE. The component 198 may be configured to switch from the serving cell to the target cell. The component 198 may be configured to switch back to the serving cell, utilizing the first TCI state list that is maintained as activated at the UE for the duration of time, based on a failure associated with the switch from the serving cell to the target cell. The component 198 may be configured to receive the second TCI state list and the first TCI state list at a different time occasion than the second TCI state list. The component 198 may be configured to maintain, subsequent to the switch from the serving cell to the target cell and based on the state list indication, the first TCI state list and the second TCI state list. The component 198, where a third TCI state list associated with the first cell configuration is received, may be configured to maintain, based on the state list indication, the first TCI state list or the third TCI state list. In the various aspects, the component 198 may be configured to transmit, for the network node, a capability indication that indicates at least one capability of the UE associated with the mobility of the UE, where the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command. In certain aspects, the base station 102 may have a mobility component 199 (“component 199”) that may be configured to operate in accordance with the component 198 for network side operations/functions. Accordingly, aspects herein enable a UE to utilize TCI state information before and after cell switching commands for LTM. TCI state information may be outside cell configurations, but after cell switch commands, and aspects provide for consolidation with cell configurations.

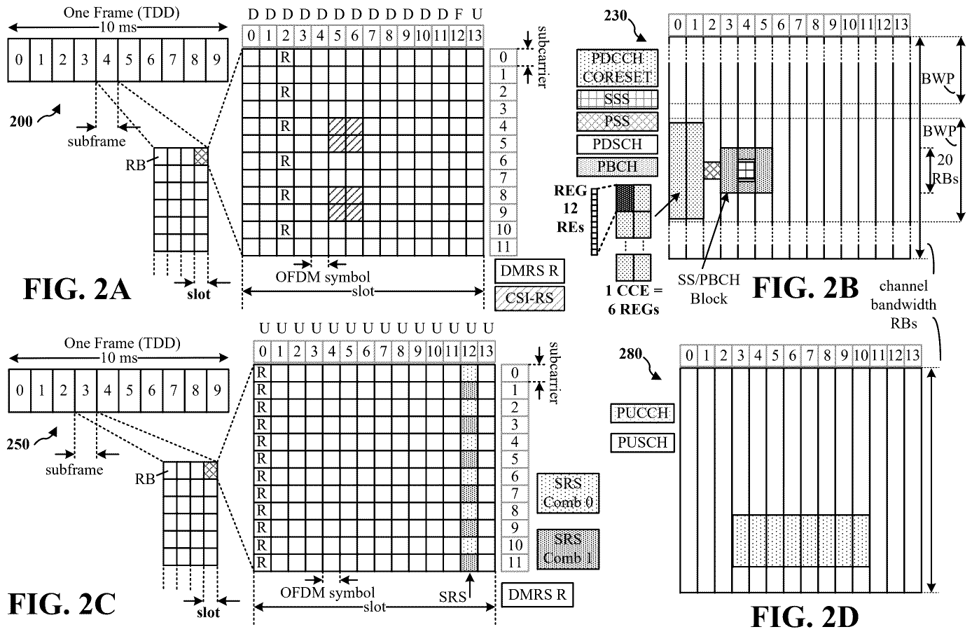

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

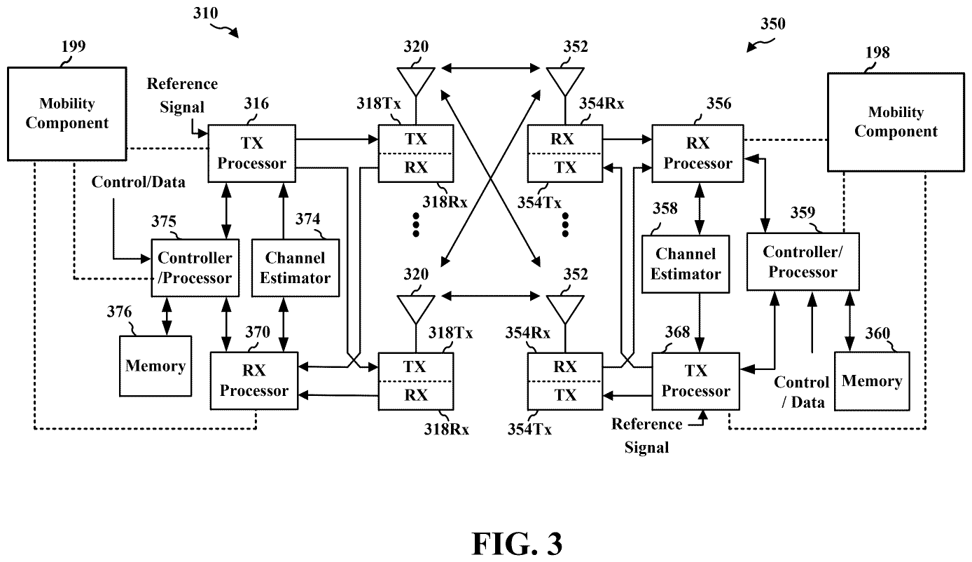

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

UE mobility may be LTM in which an associated cell for a UE may be updated using L1/L2 signaling from a network to a UE. The updates may be based on an L1 measurements (e.g., intra- and/or inter-frequency measurements). As an example, a UE may be initially served by one or more serving cells, which may include a special cell (SpCell) and/or one or more secondary cells (Cells), while candidate cells may be available to the UE for LTM. An SpCell may be a primary cell (PCell) or a primary secondary cell (PSCell). The UE may receive LTM communications from the serving cell for a move, using LTM, to a target cell, e.g., one of the candidate cells, as a new serving cell. The UE may then move to the target cell and initiate communications therewith (e.g., configurations for beams, a transmission configuration indication (TCI), a random access channel (RACH), etc.). However, TCI state activation of a candidate and/or target cell may be received before the reception of a beam indication(s) of the candidate and/or target cell, in some scenarios, while the TCI state activation of a candidate and/or target cell may be received together with the reception of beam indication of the candidate and/or target cell, in other scenarios. These two scenarios may also both be supported based on the capability(ies) of the moving UE, which may entail various beam indication and/or TCI activation timing relationships. When TCI state lists are used before cell switching, the TCI state lists may be used before, or together with, the cell switch command, and such TCI state lists may be configured external to configurations of both source/serving cell and target/candidate cells. Yet, when TCI state lists are used after cell switching, the TCI state lists may be used after a cell switching command and can be configured inside the target/candidate cell configuration. Thus, the relationship between these two TCI state list scenarios may impose complexity and timing issues. Likewise, a UE may receive TCI activations for multiple serving/candidate cells at different time occasions, and/or a UE may receive TCI activations for candidate cells when the UE has already been activated with a TCI for a serving cell. If the total number of activated TCIs exceeds the UE capability, the UE may not be configured to efficiently handle such a case. Similarly, when multiple candidate cells have activated TCIs, but only a subset thereof becomes a target cell(s) by a cell switch command(s), the remaining, non-selected cells are still candidate cells, and the UE may not be configured to efficiently handle such a case.

Various aspects herein for TCI before and after a cell switch command in a candidate cell and activated TCI selection for LTM may can be used to enable a UE to manage TCI state lists that are used before, or together with, cell switch commands where the TCI state lists are configured external to configurations of both source/serving cell and target/candidate cells, and that are used after cell switching commands where the TCI state lists are configured inside target/candidate cell configurations, by adaptively configuring a UE for TCI state lists before and after cell switching commands. Such aspects also may allow a UE to receive TCI activations for multiple serving and candidate cells at different time occasions by enabling the UE to perform down selection of activated TCIs. Aspects herein may also enable a UE to support activated TCIs for the target cell(s) by configuring the UE to maintain or deactivate non-selected, candidate cell TCI activations after a target cell(s) is selected based on the UE capability.

Aspects herein enable a UE to utilize TCI state information before and after cell switching commands. TCI state information may be outside cell configurations but after cell switch commands, and aspects provide for consolidation with cell configurations.

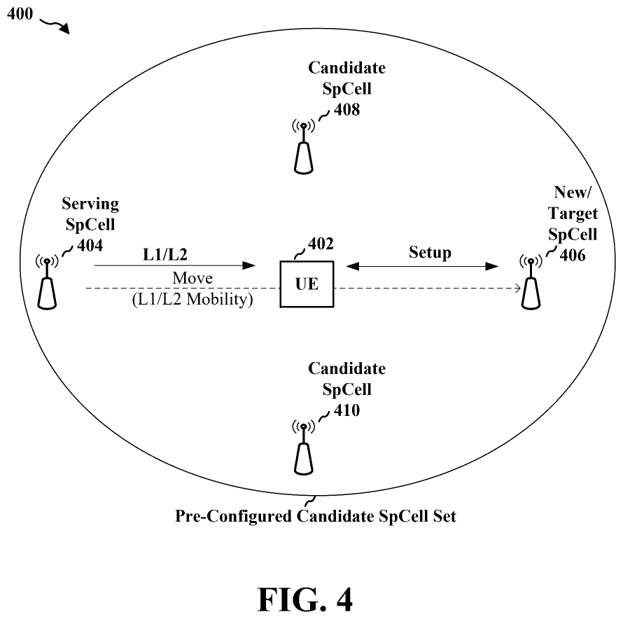

FIG. 4 is a diagram 400 illustrating an example configuration in UE mobility, in various aspects. In diagram 400, a UE 402 may be initially served by an SpCell 404, while three candidate cells (e.g., a pre-configured candidate SpCell set) are available to the UE 402 for mobility: an SpCell 406, an SpCell 408, and an SpCell 410. After measurements performed by the UE 402 against the SpCells shown, the UE 402 may receive mobility communications from SpCell 404 (e.g., a mobility command) for a move via mobility to SpCell 406, e.g., a target cell, as the new serving cell. Such mobility may be LTM in various aspects. The UE 402 then moves to the SpCell 406 and initiates its setup (e.g., configurations for beams, TCI, RACH, etc.) for communications with the SpCell 406.

SpCells are illustrated in the diagram 400 by way of example and not limitation. Aspects herein contemplate SCell implementations in addition to, or lieu of, SpCell implementations. Additionally, more or fewer cells may be present in different configurations, according to aspects.

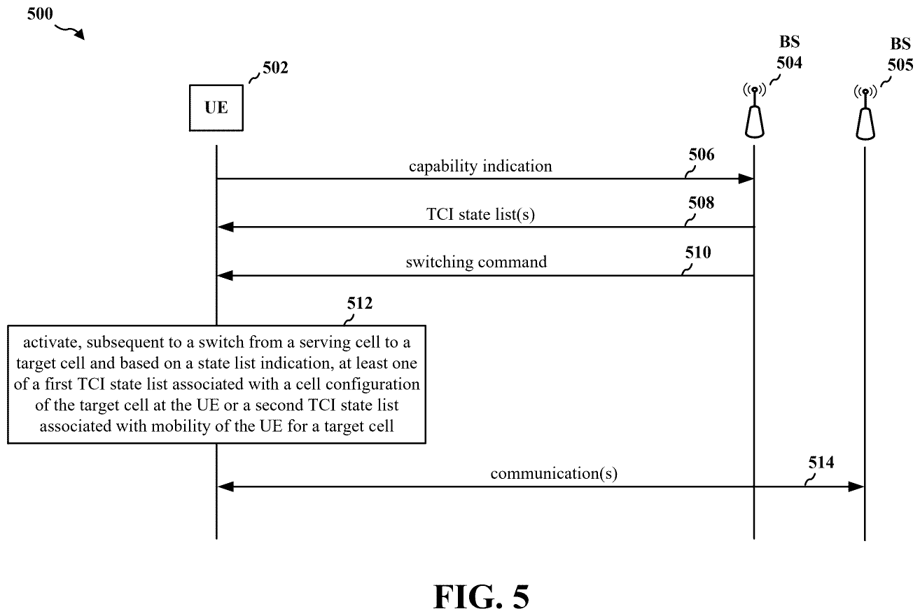

FIG. 5 is a call flow diagram 500 for wireless communications, in various aspects. Call flow diagram 500 illustrates TCI before and after a cell switch command in a candidate cell and activated TCI selection for LTM at a wireless device (a UE 502, by way of example) that is initially served by a serving cell such as a network node (a base station 504, such as a gNB or other type of base station, by way of example, as shown) and that may move (e.g., using mobility/LTM) to a candidate/target cell such as a target network node a base station 505 (such as a gNB or other type of base station, by way of example, as shown), in various aspects. Aspects described for the base station 504 and/or the base station 505 may be performed by the base station in aggregated form and/or by one or more components of the base station in disaggregated form. Additionally, or alternatively, the aspects may be performed by the UE 502 autonomously, in addition to, and/or in lieu of, operations of the base station 504 and/or the base station 505. The base station 504 and/or the base station 505 may be configured to provide at least one cell, in aspects.

In the illustrated aspect, the UE 502 may be configured to provide/transmit, and the base station 504 may be configured to receive, a capability indication 506. The capability indication 506 may indicate at least one capability of the UE 502 associated with the mobility (e.g., LTM) of the UE 502. The at least one capability may indicate support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

The UE 502 may be configured to receive, and the base station 504 may be configured to provide/transmit, a TCI state list 508 (also “TCI state list(s) 508), which may include one or more TCI state lists in aspects. In aspects, a TCI state list may include one or more TCIs for a cell, such as a serving cell (e.g., the base station 504), a candidate cell(s) (e.g., the base station 505 and/or other base stations not shown for illustrative clarity and brevity), and/or a target cell (e.g., the base station 505). In aspects, candidate cells may be cells to which the UE 502 may move using mobility/LTM, and a target cell(s) may be the cell(s) to which the UE 502 moves, where the target cell(s) becomes a new serving cell(s) after the mobility/LTM operations (e.g., after a handover). The TCI state list 508 may be provided as a “dl-OrJoint-TCIStateList” and/or an “ul-TCI-StateList,” in aspects. The TCI state list 508 may include one or more TCI state lists that are provided together, provided separately, provided concurrently, and/or provided at different time occasions. One or more TCIs of the TCI state list 508 may each include a numeric TCI identifier (ID) from a TCI ID pool. In aspects, each TCI of the TCI state list 508 may have a unique TCI ID, while each TCI state list 508 may include TCIs that have a same TCI ID.

In some aspects, the TCI state list 508 may be provided/transmitted to, and received by, the UE 502 prior to receiving a switching command 510, e.g., for LTM, from the base station 504 for the UE 502 to switch to the base station 505, and in some other aspects, the TCI state list 508 may be provided/transmitted to, and received by, the UE 502 together with the switching command 510, each of which may be prior to activation of at least one TCI at the UE 502. After the cell switch triggered by the switching command 510, the UE 502 may be configured to activate (at 512), subsequent to a switch from a serving cell to a target cell and based on a state list indication, at least one of a first TCI state list associated with a cell configuration of the target cell at the UE or a second TCI state list associated with mobility of the UE for a target cell. That is, after the switch from the base station 504 to the base station 505, the UE 502 may activate (at 512) ones of the TCI state list 508 associated with a cell configuration of the base station 505 (e.g., the target cell) at the UE 502 and/or associated with ones of the TCI state list 508 associated with mobility of the UE 502 for the base station 505 (e.g., the target cell) based on the state list indication. The UE 502 may be configured, according to the state list indication, to transmit/provide and receive (e.g., exchange) communications 514 with the base station 505 based on the first and/or the second TCI state list of the TCI state list 508. In aspects, the state list indication may be a set of state list conditions, stored/maintained at the UE 502, based on pre-configuration, based on a communication from the base station 504, and/or the like. In aspects, the state list indication may be provided to the UE 502 dynamically by the base station 504, as described in further detail below. In aspects, a network node as used herein may be a serving cell of a UE and/or may be a candidate/target cell of a UE.

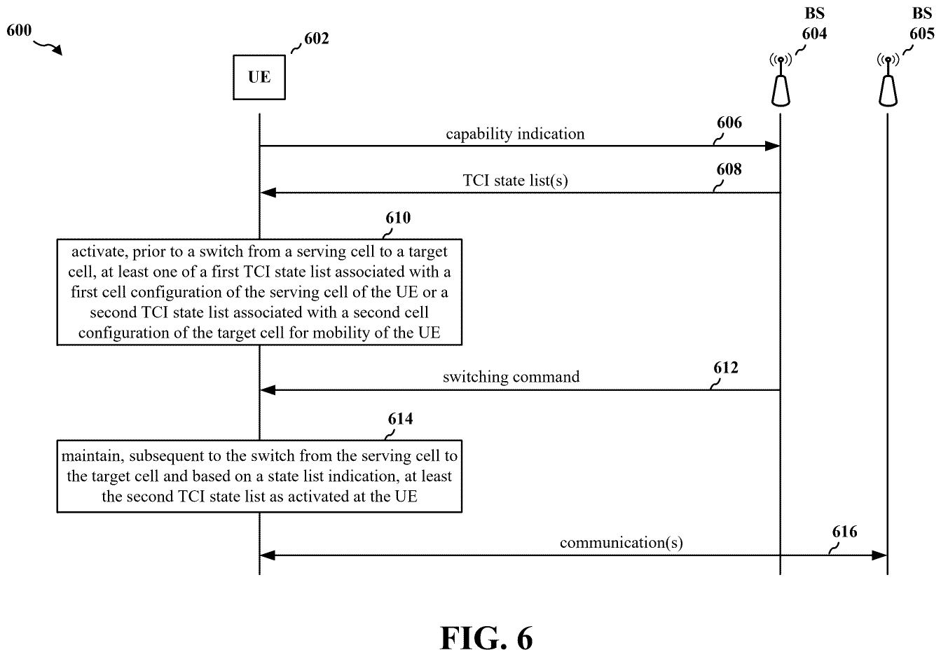

FIG. 6 is a call flow diagram 600 for wireless communications, in various aspects. Call flow diagram 600 illustrates TCI before and after a cell switch command in a candidate cell and activated TCI selection for LTM at a wireless device (a UE 602, by way of example) that is initially served by a serving cell such as a network node (a base station 604, such as a gNB or other type of base station, by way of example, as shown) and that may move (e.g., using mobility/LTM) to a candidate/target cell such as a target network node a base station 605 (such as a gNB or other type of base station, by way of example, as shown), in various aspects. Aspects described for the base station 604 and/or the base station 605 may be performed by the base station in aggregated form and/or by one or more components of the base station in disaggregated form. Additionally, or alternatively, the aspects may be performed by the UE 602 autonomously, in addition to, and/or in lieu of, operations of the base station 604 and/or the base station 605. The base station 604 and/or the base station 605 may be configured to provide at least one cell, in aspects.

In the illustrated aspect, the UE 602 may be configured to provide/transmit, and the base station 604 may be configured to receive, a capability indication 606. The capability indication 606 may indicate at least one capability of the UE 602 associated with the mobility (e.g., LTM) of the UE 602. The at least one capability may indicate support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

The UE 602 may be configured to receive, and the base station 604 may be configured to provide/transmit, a TCI state list 608 (also “TCI state list(s) 608), which may include one or more TCI state lists in aspects. In aspects, a TCI state list may include one or more TCIs for a cell, such as a serving cell (e.g., the base station 604), a candidate cell(s) (e.g., the base station 605 and/or other base stations not shown for illustrative clarity and brevity), and/or a target cell (e.g., the base station 605). In aspects, candidate cells may be cells to which the UE 602 may move using mobility/LTM, and a target cell(s) may be the cell(s) to which the UE 602 moves, where the target cell(s) becomes a new serving cell(s) after the mobility/LTM operations (e.g., after a handover). The TCI state list 608 may be provided as a “dl-OrJoint-TCIStateList” and/or an “ul-TCI-StateList,” in aspects. The TCI state list 608 may include one or more TCI state lists that are provided together, provided separately, provided concurrently, and/or provided at different time occasions. One or more TCIs of the TCI state list 608 may each include a numeric TCI ID from a TCI ID pool. In aspects, each TCI of the TCI state list 608 may have a unique TCI ID, while each TCI state list 608 may include TCIs that have a same TCI ID.

In some aspects, the TCI state list 608 may be provided/transmitted to, and received by, the UE 602 prior to receiving a switching command 612, e.g., for LTM, from the base station 604 for the UE 602 to switch to the base station 605, and the switching command 612 may be received by the UE 602 subsequent to activation of at least one TCI at the UE 602. The UE 602 may be configured to activate (at 610), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. That is, before the switch from the base station 604 to the base station 605, the UE 602 may activate (at 610) ones of the TCI state list 608 associated with a cell configuration of the base station 604 (e.g., the serving cell) at the UE 602 and/or associated with ones of the TCI state list 608 associated with mobility of the UE 602 for the base station 505 (e.g., the target cell).

After the cell switch triggered by the switching command 612, the UE 602 may be configured to maintain (at 614), subsequent to the switch from the serving cell to the target cell and based on a state list indication, at least the second TCI state list as activated at the UE. That is, after the switch from the base station 604 to the base station 605, the UE 602 may maintain (at 614), from the TCI state list 608, activation of the TCI(s) associated with the cell configuration of the base station 605 (e.g., the target cell) at the UE 602, and the UE 602 may also be configured to maintain (at 614) or deactivate (as described in further detail below), from the TCI state list 608, the activated TCI(s) associated with the mobility/LTM of the UE 602 for the base station 604 (e.g., the serving cell).

The UE 602 may be configured, according to the state list indication, to transmit/provide and receive (e.g., exchange) communications 616 with the base station 605 based on the second TCI state list, and may be configured to maintain or deactivate the first TCI state list of the TCI state list 608. In aspects, the state list indication may be a set of state list conditions, stored/maintained at the UE 602, based on pre-configuration, based on a communication from the base station 604, and/or the like. In aspects, the state list indication may be provided to the UE 602 dynamically by the base station 604, as described in further detail below. In aspects, a network node as used herein may be a serving cell of a UE and/or may be a candidate/target cell of a UE.

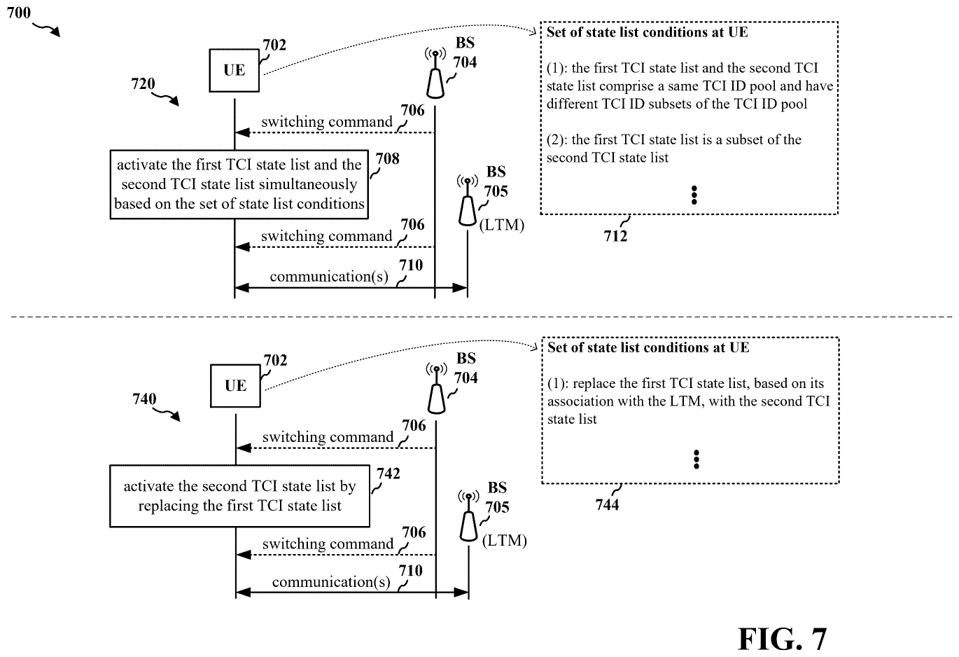

FIG. 7 is a diagram 700 illustrating examples for TCI configurations and activations in UE LTM, in various aspects. Diagram 700 shows a UE 702 (e.g., an aspect of the UE 502 in FIG. 5), a serving cell represented as a base station 704 (e.g., an aspect of the base station 504 in FIG. 5), and a candidate/target cell a base station 705 (e.g., an aspect of the base station 505 in FIG. 5). Diagram 700 illustrates a configuration 720 and a configuration 740 for TCI activations in UE LTM, each of which may be an aspect of call flow diagram 500 in FIG. 5.

In the configuration 720, the UE 702 may be configured to receive a switching command 706, as similarly described above for the switching command 510 in FIG. 5 (e.g., subsequent to receiving one or more TCI state lists (TCI state list 508) that include a first and a second TCI state list) or for the switching command 612 in FIG. 6 (e.g., subsequent to receiving one or more TCI state lists (TCI state list 508) that include a first and a second TCI state list). As noted above, for FIG. 5, the UE 502 may be configured to activate (at 512), subsequent to a switch from a serving cell to a target cell and based on a state list indication 712, and for FIG. 6, the UE 602 may be configured to activate (at 610), prior to a switch from a serving cell to a target cell, at least one of a first TCI state list associated with a first cell configuration of the serving cell of the UE or a second TCI state list associated with a second cell configuration of the target cell for mobility of the UE. In aspects, the UE 702 may be configured to activate (at 708) the first TCI state list and the second TCI state list simultaneously based on the set of state list conditions 712. As shown in the configuration 720, the state list indication 712 may be a set of state list conditions 712 maintained at the UE 702. The set of state list conditions 712 may include a first state list condition where the first TCI state list and the second TCI state list comprise a same TCI ID pool and have different TCI ID subsets of the TCI ID pool, and may include a second state list condition where the first TCI state list is a subset of the second TCI state list. Where the properties/characteristics of the first TCI state list and the second TCI state list meet at least one of the set of state list conditions 712, the UE 702 may be configured to activate (at 708) the first TCI state list and the second TCI state list simultaneously.

Subsequently, the UE 702 may exchange communications 710 with the target base station, e.g., the base station 705, according to the activated TCIs.

In the configuration 740, the UE 702 may be configured to receive the switching command 706, as similarly described above for the switching command 510 in FIG. 5 (e.g., subsequent to receiving one or more TCI state lists (TCI state list 508) that include a first and a second TCI state list) or for the switching command 612 in FIG. 6 (e.g., subsequent to receiving one or more TCI state lists (TCI state list 508) that include a first and a second TCI state list). As noted above, for FIG. 5, the UE 502 may be configured to activate (at 512), subsequent to a switch from a serving cell to a target cell and based on a state list indication 744, and for FIG. 6, the UE 602 may be configured to activate (at 610), prior to a switch from a serving cell to a target cell, at least one of a first TCI state list associated with a first cell configuration of the serving cell of the UE or a second TCI state list associated with a second cell configuration of the target cell for mobility of the UE. In aspects, the UE 702, where the state list indication 744 is a set of state list conditions, may be configured to activate (at 742) the second TCI state list by replacing the first TCI state list. As shown in the configuration 740, the state list indication 744 may be a set of state list conditions maintained at the UE 702. The set of state list conditions 744 may include indicate replace the first TCI state list, based on its association with the LTM, with the second TCI state list. Where the properties/characteristics of the first TCI state list (e.g., associated with the mobility/LTM), and the second TCI state list (e.g., for replacement of the first TCI state list), meet at least one of the set of state list conditions 744, the UE 702 may be configured to activate (at 742) the second TCI state list by replacement of the first TCI state list.

Subsequently, the UE 702 may exchange the communications 710 with the target base station, e.g., the base station 705, according to the activated TCIs.

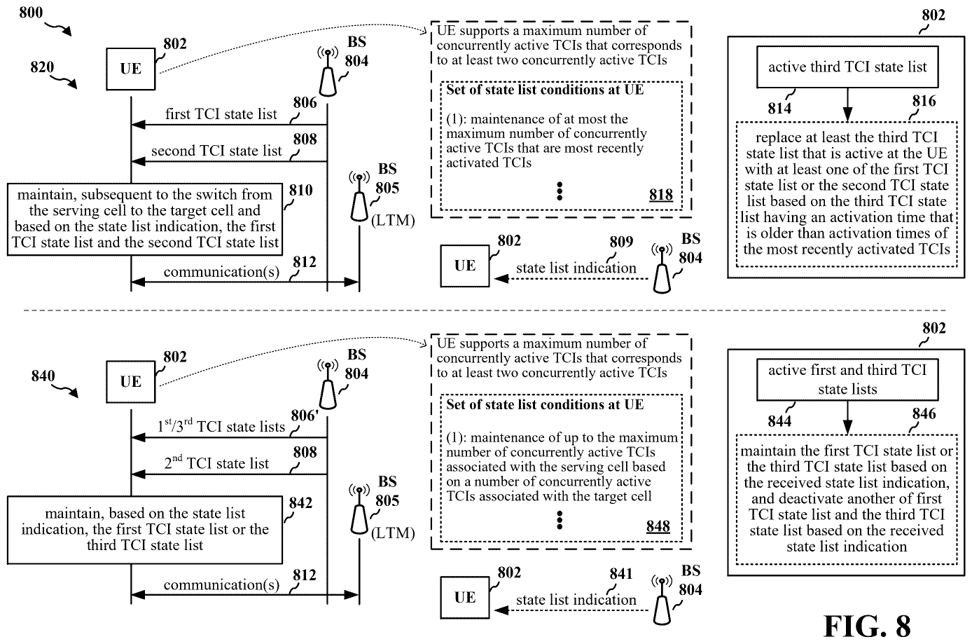

FIG. 8 is a diagram 800 illustrating examples for TCI configurations and activations in UE LTM, in various aspects. Diagram 800 shows a UE 802 (e.g., an aspect of the UE 502 in FIG. 5 and/or the UE 602 in FIG. 6), a serving cell represented as a base station 804 (e.g., an aspect of the base station 504 in FIG. 5 and/or the base station 604 in FIG. 6), and a candidate/target cell represented as a base station 805 (e.g., an aspect of the base station 505 in FIG. 5 and/or the base station 605 in FIG. 6). Diagram 800 illustrates a configuration 820 and a configuration 840 for TCI activations in UE LTM, each of which may be an aspect of the call flow diagram 500 in FIG. 5 and/or the call flow diagram 600 in FIG. 6.

The UE 802 may be configured to receive TCI activations for multiple serving and/or candidate cells at different time occasions, and if the total number of activated TCIs exceeds the UE 802 capability, down selection of the TCIs/TCI state lists may be utilized by the UE 802. For instance, and by way of example, in LTM, when the UE 802 supports X>1 activated TCIs in total for both serving and candidate cells, if the UE 802 receives multiple TCI activations for a set of serving and candidate cells at different time occasions, the UE 802 may maintain up to X activated TCIs for a subset of the cells based on configurations. In one aspect, the configuration for the UE 802 may be rule based, e.g., using a set of state list conditions, while in another aspect, the UE 802 may receive signaling, e.g., from the base station 804, for TCI maintenance/activation and/or deactivation for each cell, when the number of activated TCIs exceed X.

In the configuration 820, for a rule based configuration, the UE 802 may support a maximum number of concurrently active TCIs that corresponds to at least two concurrently active TCIs. The UE 802 may be configured to receive a first TCI state list 806 (e.g., of the TCI state list 508 in FIG. 5) at a different time occasion than a second TCI state list 808, such as prior to the second TCI state list 808, as shown. The UE 802 may be configured to maintain (at 810), subsequent to the switch from the serving cell to the target cell and based on the state list indication 809, the first TCI state list and the second TCI state list.

In one example, the state list indication 809 may be a set of state list conditions 818 and may indicate maintenance of at most the maximum number of concurrently active TCIs that are most recently activated TCIs. In another example, the UE 802 may be configured to receive, and the base station 804 may be configured to provide/transmit, the state list indication (e.g., a state list indication 809) that indicates the maintenance of at most the maximum number of concurrently active TCIs that are most recently activated TCIs. That is, the cells for which TCI state lists are maintained may be the subset of cells with the latest TCI activation indications, for cells with newer TCI activations, and the UE 802 may implicitly replace cells with older TCI activations when the number of activated TCIs exceed X, noted above. One advantage of such a configuration is that it may save signaling for TCI deactivation between the UE 802 and the base station 804.

In aspects, by way of example, at least a third TCI state list 814 may be active at the UE 802 and, together with the first TCI state list 806 and the second TCI state list 808, the maximum number of concurrently active TCI state lists (e.g., X) may be exceeded. The third TCI state list may be received by the UE 802 together with or separate from the first and second TCI set lists as transmitted/provided by the base station 804. In aspects for the set of state list conditions 818, and for receiving the state list condition (e.g., dynamically from the base station 804), the UE 802 may be configured to replace (at 816) at least the third TCI state list that is active at the UE with at least one of the first TCI state list or the second TCI state list based on the third TCI state list having an activation time that is older than activation times of the most recently activated TCIs.

In different aspects, a switching command, as similarly described above for the switching command 510 in FIG. 5 (e.g., subsequent to receiving one or more TCI state lists (TCI state list 508) that includes a first and a second TCI state list) may be received by the UE 502, and a switching command, as similarly described above for the switching command 612 in FIG. 6 (e.g., subsequent to receiving one or more TCI state lists (TCI state list 608) that includes a first and a second TCI state list) may be received by the UE 602. As noted above for FIG. 5, the UE 502 may be configured to activate (at 512), subsequent to a switch from a serving cell to a target cell and based on a state list indication 809, at least one of a first TCI state list associated with a cell configuration of the target cell at the UE 502 or a second TCI state list associated with mobility of the UE 502 for a target cell, while in FIG. 6, the UE 602 may be configured to activate (at 610), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. Aspects herein for the configuration 820 contemplate the maintenance (at 810) and/or the replacement (at 816) for the operations/functions described for either or both of the call flow diagrams in FIGS. 5, 6.

Subsequently, the UE 802 may exchange the communications 812 with the target base station, e.g., the base station 805, according to the activated TCIs.

The UE 802 may be configured to receive TCI activations for candidate cells (e.g., including target cells) when the UE 802 has been activated with TCI for serving cell, and if the total number of activated TCIs exceeds the UE 802 capability, down selection of the TCIs/TCI state lists may be utilized by the UE 802. For instance, and by way of example, in LTM, when the UE 802 supports X>1 activated TCIs in total for both serving and candidate cells, if the UE 802 receives X TCI activations for a serving cell (e.g., the base station 804), and Y<X activated TCIs for candidate cells (e.g., the base station 805 and/or other candidate cells) before a cell switching command is received, the UE 802 may determine which X-Y (X minus Y) activated TCIs are to be maintained as active/activated in the serving cell. In one aspect, the configuration for the UE 802 may be rule based, e.g., using a set of state list conditions 818, while in another aspect, the UE 802 may receive signaling, e.g., from the base station 804, for TCI activation/deactivation, to ensure up to X-Y (X minus Y) TCIs are activated for the serving cell.

In the configuration 840, for a rule based configuration, the UE 802 may support a maximum number of concurrently active TCIs that corresponds to at least two concurrently active TCIs. The UE 802 may be configured to receive a first and third TCI state list 806′ (e.g., of the TCI state list 508 in FIG. 5) and the second TCI state list 808, such as concurrently with or after (e.g., at a different time occasion) the first and third TCI state list 806′. The UE 802 may be configured to maintain (at 842), based on the state list indication 841, the first TCI state list or the third TCI state list.

In one example, the state list indication 841 may be a set of state list conditions 848 and may indicate maintenance of up to the maximum number of concurrently active TCIs associated with the serving cell based on a number of concurrently active TCIs associated with the target cell. In another example, the UE 802 may be configured to receive, and the base station 804 may be configured to provide/transmit, the state list indication (e.g., a state list indication 841) that indicates the maintenance of up to the maximum number of concurrently active TCIs associated with the serving cell based on a number of concurrently active TCIs associated with the target cell. That is, the cells for which TCI state lists are maintained may have the first X-Y (X minus Y) lowest TCI IDs activated for the serving cell, and the UE 802 may keep these TCIs active/activated (e.g., maintained), while in aspects, the higher TCIs may not be maintained and/or may be deactivated/replaced. One advantage of such a configuration is that it may save signaling for TCI deactivation between the UE 802 and the base station 804.

In aspects, by way of example, first and third TCI state lists 844 may be active at the UE 802 and, together with the second TCI state list 808, and any other active TCIs in TCI state lists not shown for brevity and clarity, the maximum number of concurrently active TCI state lists (e.g., X) for serving and candidate cells may be exceeded. In aspects for the set of state list conditions 848, and for receiving the state list condition (e.g., dynamically from the base station 804), the UE 802 may be configured to maintain (at 846) the first TCI state list or the third TCI state list based on the received state list indication 841, and deactivate another of first TCI state list and the third TCI state list based on the received state list indication 841.

In different aspects, a switching command, as similarly described above for the switching command 510 in FIG. 5 (e.g., subsequent to receiving one or more TCI state lists (TCI state list 508) that includes a first and a second TCI state list). As noted above for FIG. 5, the UE 502 may be configured to activate (at 512), subsequent to a switch from a serving cell to a target cell and based on a state list indication 841, at least one of a first TCI state list associated with a cell configuration of the target cell at the UE 502 or a second TCI state list associated with mobility of the UE 502 for a target cell, while in FIG. 6, the UE 602 may be configured to activate (at 610), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. Aspects herein for the configuration 820 contemplate the maintenance (at 842) and/or the maintenance (at 846) for the operations/functions described for either or both of the call flow diagrams in FIGS. 5, 6.

Subsequently, the UE 802 may exchange the communications 812 with the target base station, e.g., the base station 805, according to the activated TCIs.

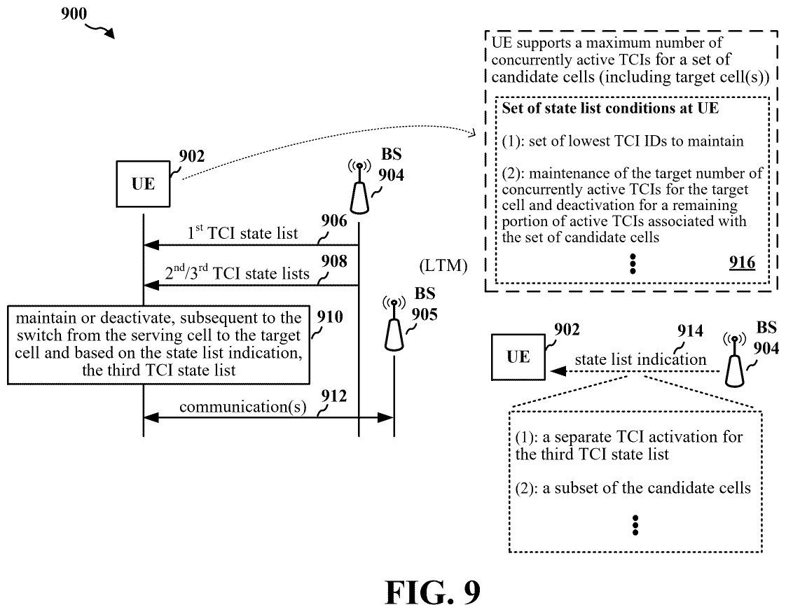

FIG. 9 is a diagram 900 illustrating an example for TCI configurations and activations in UE LTM, in various aspects. Diagram 900 shows a UE 902 (e.g., an aspect of the UE 502 in FIG. 5), a serving cell represented as a base station 904 (e.g., an aspect of the base station 504 in FIG. 5), and a candidate/target cell represented as a base station 905 (e.g., an aspect of the base station 505 in FIG. 5). Diagram 900 illustrates a configuration for TCI activations in UE LTM, which may be an aspect of the call flow diagram 500 in FIG. 5.

The UE 902 may be associated with multiple candidate cells with activated TCIs, but only a subset of the multiple candidate cells may become target cells by a cell switch command(s). The remaining, non-selected cells may still remain as candidate cells, and the UE 902 may be configured to maintain/activate and/or deactivate the activated TCIs for the non-selected cells. For instance, and by way of example, in LTM, when the UE 902 supports X>1 activated TCIs in total for candidate cells, if the UE 902 desires or is configured to maintain Y activated TCIs for the new target cells after the cell switch command(s), the UE 902 may determine which X-Y (X minus Y) activated TCIs are to be maintained/kept in the non-selected candidate cells that are not switched on. In one aspect, the configuration for the UE 902 may be rule based, e.g., using a set of state list conditions 916, while in another aspect, the UE 902 may receive signaling, e.g., from the base station 904, for TCI maintenance/activation and/or deactivation for each cell, to maintain/keep the desired/configured X-Y (X minus Y) activated TCIs for the non-selected candidate cells.

In the configuration shown for the diagram 900, for a rule based/implicit configuration, the UE 902 may support a maximum number of concurrently active TCIs for a set of candidate cells, which may include a target cell(s). The UE 902 may be configured to receive a first TCI state list 906 (e.g., of the TCI state list 508 in FIG. 5) and second and third TCI state lists 908, such as prior to, or at the same time as, the first TCI state list 906. The UE 902 may be configured to maintain or deactivate (at 910), subsequent to the switch from the serving cell to the target cell and based on the state list indication, the third TCI state list.

In one example, the state list indication 914 may be a set of state list conditions 916 and may indicate (1) a set of lowest TCI IDs to maintain and/or (2) maintenance of the target number of concurrently active TCIs for the target cell and deactivation for a remaining portion of active TCIs associated with the set of candidate cells. In another example, the UE 902 may be configured to receive, and the base station 904 may be configured to provide/transmit, the state list indication (e.g., a state list indication 914) that indicates (1) a separate TCI activation for the third TCI state list and/or (2) a subset of the candidate cells. That is, the UE 902 may be configured to utilize rule based/implicit configurations where X-Y (X minus Y) TCIs are activated for the first lowest ID candidate cells and/or implicit deactivation for all candidate cells not switched on after a cell switch command (e.g., where all TCI activations for candidate cells not switched on are deactivated by a cell switch command), which may save signaling for TCI deactivation between the UE 902 and the base station 904, and the UE 902 may be configured to utilize the state list indication 914, by signaling, for a new TCI activation(s) for each candidate cell (e.g., the UE 902 expects an explicit new TCI activation for each candidate cell) and/or a base station indication whereby the UE 902 may be indicated to maintain/keep TCIs activated for a subset of candidate cells.

In aspects, by way of example, at least a third TCI state list, which may be associated with a candidate cell configuration that is separate from the cell configuration of a target cell(s), may be received with a second TCI state list (e.g., the second and third TCI state lists 908). In aspects for the set of state list conditions 916, and for receiving the state list condition (e.g., dynamically from the base station 904), the UE 902 may be configured to maintain or deactivate (at 910) the third TCI state list (1) based on TCIs associated with the third TCI state list having TCI IDs in the set of lowest TCI IDs where the state list indication 914 is the set of state list conditions 916 that indicates a set of lowest TCI IDs, (2) based on the received state list activation indicates a separate TCI activation (which may indicate activation/deactivation) for the third TCI state list, (3) based on the set of state list conditions 916 that is a set of state list conditions and that indicates maintenance of the target number of concurrently active TCIs for the target cell and deactivation for a remaining portion of active TCIs associated with the set of candidate cells, and/or (4) based on the third TCI state list being associated with a candidate cell included in the subset of the candidate cells that is indicated by the received state list activation.

In different aspects, a switching command, as similarly described above for the switching command 510 in FIG. 5 (e.g., subsequent to receiving one or more TCI state lists (TCI state list 508) that includes a first and a second TCI state list) may be received by the UE 502. As noted above for FIG. 5, the UE 502 may be configured to activate (at 512), subsequent to a switch from a serving cell to a target cell and based on a state list indication 914, at least one of a first TCI state list associated with a cell configuration of the target cell at the UE 502 or a second TCI state list associated with mobility of the UE 502 for a target cell. Aspects herein for the configuration in the diagram 900 contemplate the maintenance or deactivation (at 910) for the operations/functions described for the call flow diagram in FIG. 5.

Subsequently, the UE 902 may exchange the communications 912 with the target base station, e.g., the base station 905, according to the activated TCIs.

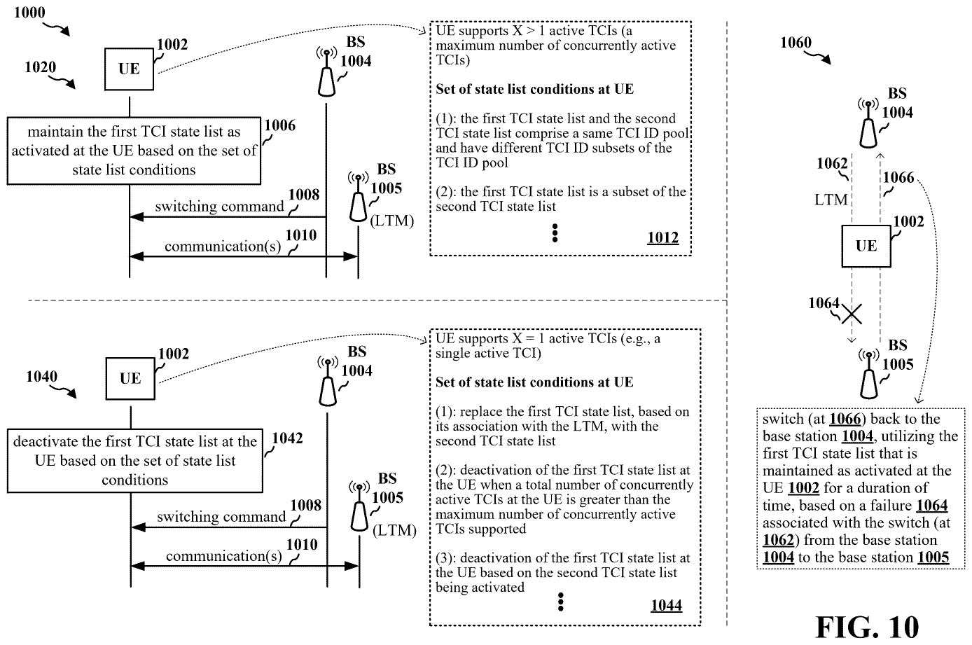

FIG. 10 is a diagram 1000 illustrating examples for TCI configurations and activations in UE LTM, in various aspects. Diagram 1000 shows a UE 1002 (e.g., an aspect of the UE 602 in FIG. 6), a serving cell represented as a base station 1004 (e.g., an aspect of the base station 604 in FIG. 6), and a candidate/target cell represented as a base station 1005 (e.g., an aspect of the base station 605 in FIG. 6). Diagram 1000 illustrates a configuration 1020, a configuration 1040, and a configuration 1060 for TCI activations in UE LTM each of which may be an aspect of the call flow diagram 600 in FIG. 6.

The UE 1002 may be configured for LTM to receive TCI activations, e.g., activated with TCI states, for a serving cell (e.g., the base station 1004) and for a candidate cell (e.g., the base station 1004) after a switching command is received for the UE 1002 to move from the serving cell to the candidate cell. In aspects, if the UE 1002 is configured to support X>1 active TCIs, the UE 1002 may be configured to maintain the activated TCIs for the serving cell over a time duration after the cell switch to the target cell. In aspects, if the UE 1002 is configured to support X=1 active TCIs, e.g., a single active TCI, the UE 1002 may be configured to deactivate the activated TCI for the serving cell after the TCI for the target cell is activated. In one aspect, the configuration for the UE 1002 may be rule based, e.g., using a set of state list conditions, while in another aspect, the UE 1002 may receive signaling, e.g., from the base station 1004, for TCI maintenance/activation and/or deactivation for the serving cell.

In the configuration 1020 of diagram 1000, for a rule based configuration, the UE 1002 may support X>1 active TCIs. The UE 1002 may be configured to maintain (at 1006) the first TCI state list as activated at the UE 1002 based on the set of state list conditions. In other words, the UE 1002 may be configured to maintain (at 1006) the activated TCIs for the source cell over a time duration after the cell switch. The UE 1002 may be configured to receive the first and second TCI state lists (not shown for brevity and illustrative clarity; e.g., of the TCI state list 508 in FIG. 5) at a different time occasions or the same time occasion, prior to the maintenance (at 1006). The UE 1002 may be configured to receive a switching command 1008, as similarly described above for the switching command 612 in FIG. 6 (e.g., subsequent to receiving one or more TCI state lists (TCI state list 608) that include a first and a second TCI state list and subsequent to the maintenance (at 1006)) and switch to the base station 1005 while maintaining the activated TCI(s) of the first TCI state list for a configured duration of time. In aspects, this may be advantageous for the UE 1002 to more efficiently switch back to the base station 1004 (e.g., the original serving cell) if the switch to the base station 1005 (e.g., the target cell) fails for any reason.

In one example, the state list indication may be a set of state list conditions 1012 and may indicate that (1) the first TCI state list and the second TCI state list comprise a same TCI ID pool and have different TCI ID subsets of the TCI ID pool and/or that (2) the first TCI state list is a subset of the second TCI state list. Where the properties/characteristics of the first TCI state list meet at least one of the state list conditions 1012, the UE 1002 may be configured to maintain (at 1006) the first TCI state list for the base station 1004.

Subsequently, the UE 1002 may exchange communications 1010 with the target base station, e.g., the base station 1005, according to the activated TCI(s).

In the configuration 1040 of diagram 1000, for a rule based configuration, the UE 1002 may support X=1 active TCIs (e.g., a single active TCI). The UE 1002 may be configured to deactivate (at 1042) the first TCI state list as activated at the UE 1002 based on the set of state list conditions 1044. In other words, the UE 1002 may be configured to deactivate (at 1042) the activated TCIs for the source cell based on the capability(ies) of the UE 1002 to maintain active TCIs. The UE 1002 may be configured to receive the first and second TCI state lists (not shown for brevity and illustrative clarity; e.g., of the TCI state list 508 in FIG. 5) at a different time occasions or the same time occasion, prior to the deactivation (at 1042). The UE 1002 may be configured to receive the switching command 1008, as similarly described above for the switching command 612 in FIG. 6 (e.g., subsequent to receiving one or more TCI state lists (TCI state list 608) that include a first and a second TCI state list and subsequent to the deactivation (at 1042)) and switch to the base station 1005 while not maintaining the deactivated TCI(s) of the first TCI state list for the base station 1004.

In one example, the state list indication may be a set of state list conditions 1044 and may indicate to (1) replace the first TCI state list, based on its association with the LTM, with the second TCI state list, to perform (2) deactivation of the first TCI state list at the UE 1002 when a total number of concurrently active TCIs at the UE 1002 is greater than the maximum number of concurrently active TCIs supported (e.g., X=1 in this example), and/or to perform (3) deactivation of the first TCI state list at the UE 1002 based on the second TCI state list being activated. Where the properties/characteristics of the first TCI state list meet at least one of the state list conditions 1044, the UE 1002 may be configured to deactivate (at 1006) the first TCI state list for the base station 1004.

Subsequently, the UE 1002 may exchange the communications 1010 with the target base station, e.g., the base station 1005, according to the activated TCI(s).

The configuration 1060 illustrates a failure for a switch of the UE 1002 from the base station 1004 to the base station 1005, in the context of the configuration 1020 where maintenance (e.g., at 1006) of the first TCI state list for the base station 1004 is performed by the UE 1002. For instance, the UE 1002 may be configured to maintain (e.g., at 1006) of the first TCI state list for the base station 1004, and based on the switching command 1008, the UE 1002 may switch (at 1062) to the base station 1005. That is, the UE 1002 may be configured to switch from the serving cell to the target cell. In aspects, during or subsequent to the switch (at 1062), a failure 1064 associated with the switch (at 1062) from the base station 1004 to the base station 1005 may occur by or within the duration of time for which the UE 1002 has maintained (e.g., at 1006) the first TCI state for the base station 1004. The UE may be configured to switch (at 1066) back to the base station 1004, utilizing the first TCI state list that is maintained (e.g., at 1006) as activated at the UE 1002 for the duration of time, based on the failure 1064 associated with the switch (at 1062) from the base station 1004 to the base station 1005. In aspects, the duration of time may be configured by the UE 1002 and/or the base station 1004 (e.g., as a characteristic/parameter of the first TCI state list, as a list condition of the set of state list conditions 1012/1044, etc.).

Accordingly, the UE 1002 may be configured to switch back to the serving cell, utilizing the first TCI state list that is maintained as activated at the UE for the duration of time, based on a failure associated with the switch from the serving cell to the target cell. As noted above, maintenance (e.g., at 1006) of the first TCI state list for the base station 1004 may be advantageous for the UE 1002 to more efficiently switch back to the base station 1004 (e.g., the original serving cell) if the switch to the base station 1005 (e.g., the target cell) fails for any reason.

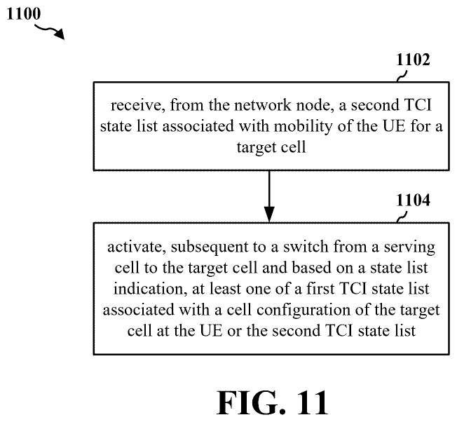

FIG. 11 is a flowchart 1100 of a method of wireless communication, in various aspects. The method may be performed by a UE (e.g., the UE 104, 402, 502, 602, 702, 802, 902, 1002; the apparatus 1504). In some aspects, the method may include aspects described in connection with the communication flow in FIG. 5 and/or aspects described in FIG. 7. The method may be for TCI before and after a cell switch command in a candidate cell and activated TCI selection for LTM, and provides improvements in UE mobility that enable a UE to utilize TCI state information before and after cell switching commands for LTM, where the TCI state information may be outside cell configurations, but after cell switch commands, and aspects provide for consolidation with cell configurations.

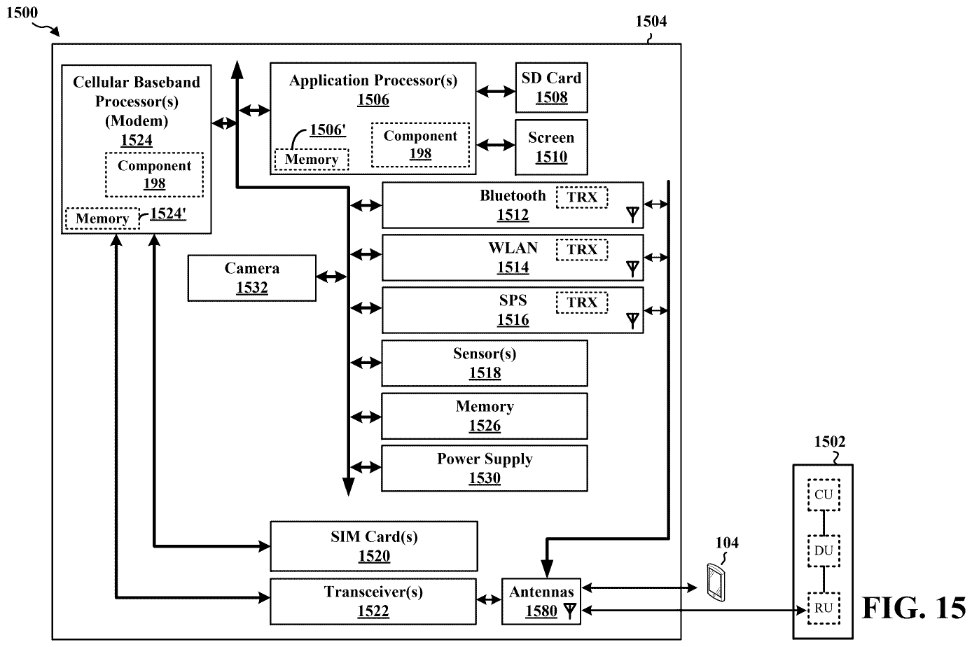

At 1102, the UE receives, from the network node, a second TCI state list associated with mobility of the UE for a target cell. As an example, the reception may be performed by one or more of the component 198, the transceiver 1522, and/or the antenna 1580 in FIG. 15. FIG. 5 illustrates an example of the UE 502 receiving a second TCI state list for mobility from a network node (e.g., the base station 504 as a serving cell).

The UE 502 may be configured to receive, and the base station 504 may be configured to provide/transmit, a TCI state list 508 (also “TCI state list(s) 508), which may include one or more TCI state lists in aspects. In aspects, a TCI state list may include one or more TCIs for a cell, such as a serving cell (e.g., the base station 504), a candidate cell(s) (e.g., the base station 505 and/or other base stations not shown for illustrative clarity and brevity), and/or a target cell (e.g., the base station 505). In aspects, candidate cells may be cells to which the UE 502 may move using mobility/LTM, and a target cell(s) may be the cell(s) to which the UE 502 moves, where the target cell(s) becomes a new serving cell(s) after the mobility/LTM operations (e.g., after a handover). The TCI state list 508 may be provided as a “dl-OrJoint-TCIStateList” and/or an “ul-TCI-StateList,” in aspects. The TCI state list 508 may include one or more TCI state lists that are provided together, provided separately, provided concurrently, and/or provided at different time occasions. One or more TCIs of the TCI state list 508 may each include a numeric TCI ID from a TCI ID pool. In aspects, each TCI of the TCI state list 508 may have a unique TCI ID, while each TCI state list 508 may include TCIs that have a same TCI ID.

In some aspects, the TCI state list 508 may be provided/transmitted to, and received by, the UE 502 prior to receiving a switching command 510, e.g., for LTM, from the base station 504 for the UE 502 to switch to the base station 505, and in some other aspects, the TCI state list 508 may be provided/transmitted to, and received by, the UE 502 together with the switching command 510, each of which may be prior to activation of at least one TCI at the UE 502.

At 1104, the UE activates, subsequent to a switch from a serving cell to the target cell and based on a state list indication, at least one of a first TCI state list associated with a cell configuration of the target cell at the UE or the second TCI state list. As an example, the reception may be performed by one or more of the component 198, the transceiver 1522, and/or the antenna 1580 in FIG. 15. FIG. 5 illustrates an example of the UE 502 activating the first TCI state list or the second TCI state list for mobility.

After the cell switch triggered by the switching command 510, the UE 502 may be configured to activate (at 512) (e.g., at 708, at 742 in FIG. 7), subsequent to a switch from a serving cell to a target cell and based on a state list indication (e.g., 712, 744 in FIG. 7), at least one of a first TCI state list associated with a cell configuration of the target cell at the UE 502 or a second TCI state list associated with mobility of the UE 502 for a target cell. That is, after the switch from the base station 504 to the base station 505, the UE 502 may activate (at 512) (e.g., at 708, at 742 in FIG. 7) ones of the TCI state list 508 associated with a cell configuration of the base station 505 (e.g., the target cell) at the UE 502 and/or associated with ones of the TCI state list 508 associated with mobility of the UE 502 for the base station 505 (e.g., the target cell) based on the state list indication (e.g., 712, 744 in FIG. 7).

The UE 502 may be configured, according to the state list indication based on the state list indication, to transmit/provide and receive (e.g., exchange) communications 514 with the base station 505 based on the first and/or the second TCI state list of the TCI state list 508. In aspects, the state list indication based on the state list indication may be a set of state list conditions (e.g., 712, 744 in FIG. 7), stored/maintained at the UE 502, based on pre-configuration, based on a communication from the base station 504, and/or the like. In aspects, the state list indication (e.g., 712, 744 in FIG. 7) may be provided to the UE 502 dynamically by the base station 504.

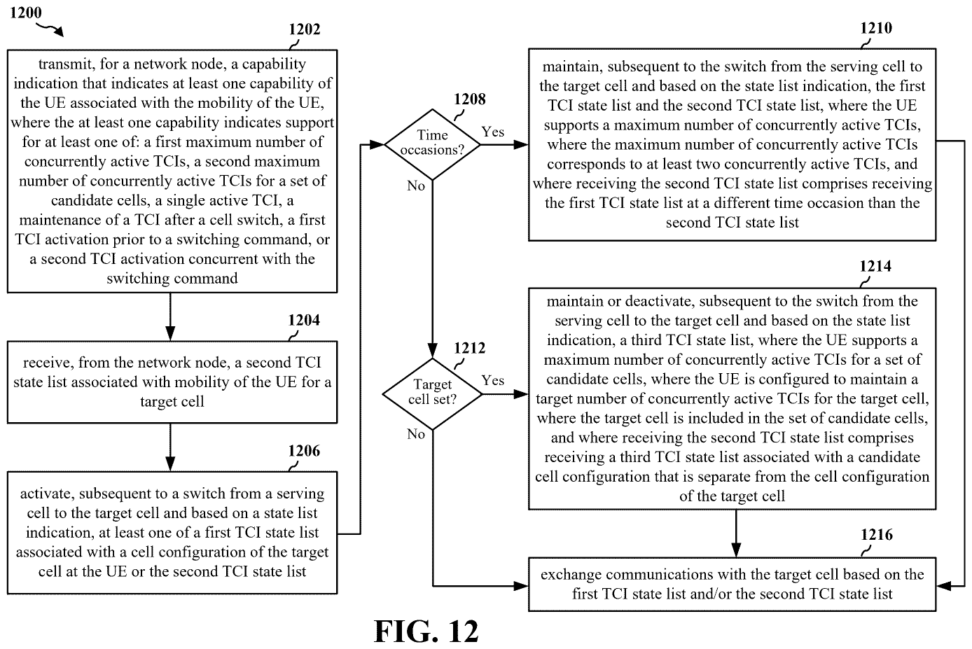

FIG. 12 is a flowchart 1200 of a method of wireless communication, in various aspects. The method may be performed by a UE (e.g., the UE 104, 402, 502, 602, 702, 802, 902, 1002; the apparatus 1504). In some aspects, the method may include aspects described in connection with the communication flow in FIG. 5 and/or aspects described in FIGS. 7, 8, 9. The method may be for TCI before and after a cell switch command in a candidate cell and activated TCI selection for LTM, and provides improvements in UE mobility that enable a UE to utilize TCI state information before and after cell switching commands for LTM, where the TCI state information may be outside cell configurations, but after cell switch commands, and aspects provide for consolidation with cell configurations.

At 1202, the UE transmits/provides, for a network node, a capability indication that indicates at least one capability of the UE associated with the mobility of the UE, where the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command. As an example, the transmission/provision may be performed by one or more of the component 198, the transceiver 1522, and/or the antenna 1580 in FIG. 15. FIG. 5 illustrates an example of the UE 502 transmitting/providing the capability indication for mobility to a network node (e.g., the base station 504 as a serving cell).

The UE 502 may be configured to provide/transmit, and the base station 504 may be configured to receive, the capability indication 506. The capability indication 506 may indicate at least one capability of the UE 502 associated with the mobility (e.g., LTM) of the UE 502. The at least one capability may indicate support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

At 1204, the UE receives, from the network node, a second TCI state list associated with mobility of the UE for a target cell. As an example, the reception may be performed by one or more of the component 198, the transceiver 1522, and/or the antenna 1580 in FIG. 15. FIG. 5 illustrates an example of the UE 502 receiving a second TCI state list for mobility from a network node (e.g., the base station 504 as a serving cell).

The UE 502 may be configured to receive, and the base station 504 may be configured to provide/transmit, a TCI state list 508 (also “TCI state list(s) 508), which may include one or more TCI state lists in aspects. In aspects, a TCI state list may include one or more TCIs for a cell, such as a serving cell (e.g., the base station 504), a candidate cell(s) (e.g., the base station 505 and/or other base stations not shown for illustrative clarity and brevity), and/or a target cell (e.g., the base station 505). In aspects, candidate cells may be cells to which the UE 502 may move using mobility/LTM, and a target cell(s) may be the cell(s) to which the UE 502 moves, where the target cell(s) becomes a new serving cell(s) after the mobility/LTM operations (e.g., after a handover). The TCI state list 508 may be provided as a “dl-OrJoint-TCIStateList” and/or an “ul-TCI-StateList,” in aspects. The TCI state list 508 may include one or more TCI state lists that are provided together, provided separately, provided concurrently, and/or provided at different time occasions. One or more TCIs of the TCI state list 508 may each include a numeric TCI ID from a TCI ID pool. In aspects, each TCI of the TCI state list 508 may have a unique TCI ID, while each TCI state list 508 may include TCIs that have a same TCI ID.

In some aspects, the TCI state list 508 may be provided/transmitted to, and received by, the UE 502 prior to receiving a switching command 510, e.g., for LTM, from the base station 504 for the UE 502 to switch to the base station 505, and in some other aspects, the TCI state list 508 may be provided/transmitted to, and received by, the UE 502 together with the switching command 510, each of which may be prior to activation of at least one TCI at the UE 502.

At 1206, the UE activates, subsequent to a switch from a serving cell to the target cell and based on a state list indication, at least one of a first TCI state list associated with a cell configuration of the target cell at the UE or the second TCI state list. As an example, the reception may be performed by one or more of the component 198, the transceiver 1522, and/or the antenna 1580 in FIG. 15. FIG. 5 illustrates an example of the UE 502 activating the first TCI state list or the second TCI state list for mobility.

After the cell switch triggered by the switching command 510, the UE 502 may be configured to activate (at 512) (e.g., at 708, at 742 in FIG. 7), subsequent to a switch from a serving cell to a target cell and based on a state list indication (e.g., 712, 744 in FIG. 7), at least one of a first TCI state list associated with a cell configuration of the target cell at the UE 502 or a second TCI state list associated with mobility of the UE 502 for a target cell. That is, after the switch from the base station 504 to the base station 505, the UE 502 may activate (at 512) (e.g., at 708, at 742 in FIG. 7) ones of the TCI state list 508 associated with a cell configuration of the base station 505 (e.g., the target cell) at the UE 502 and/or associated with ones of the TCI state list 508 associated with mobility of the UE 502 for the base station 505 (e.g., the target cell) based on the state list indication (e.g., 712, 744 in FIG. 7).

The UE 502 may be configured, according to the state list indication based on the state list indication, to transmit/provide and receive (e.g., exchange) communications 514 with the base station 505 based on the first and/or the second TCI state list of the TCI state list 508. In aspects, the state list indication based on the state list indication may be a set of state list conditions (e.g., 712, 744 in FIG. 7), stored/maintained at the UE 502, based on pre-configuration, based on a communication from the base station 504, and/or the like. In aspects, the state list indication (e.g., 712, 744 in FIG. 7) may be provided to the UE 502 dynamically by the base station 504.

At 1208, the UE determines if activation, maintenance, and/or deactivation of TCI state lists and TCIs is associated with a configuration for time occasions and a maximum number of concurrently active TCIs. If so, flowchart 1200 continues to 1210; if not, flowchart 1200 continues to 1212. As an example, the reception may be performed by one or more of the component 198, the transceiver 1522, and/or the antenna 1580 in FIG. 15.

At 1210, the UE maintains, subsequent to the switch from the serving cell to the target cell and based on the state list indication, the first TCI state list and the second TCI state list, where the UE supports a maximum number of concurrently active TCIs, where the maximum number of concurrently active TCIs corresponds to at least two concurrently active TCIs, and where receiving the second TCI state list comprises receiving the first TCI state list at a different time occasion than the second TCI state list. As an example, the reception may be performed by one or more of the component 198, the transceiver 1522, and/or the antenna 1580 in FIG. 15. FIG. 8 illustrates an example of the UE 502 maintaining the first TCI state list and the second TCI state list for mobility with reference to FIG. 5 (at 512).

The UE 802 may be configured to receive TCI activations for multiple serving and/or candidate cells at different time occasions, and if the total number of activated TCIs exceeds the UE 802 capability, down selection of the TCIs/TCI state lists may be utilized by the UE 802. For instance, and by way of example, in LTM, when the UE 802 supports X>1 activated TCIs in total for both serving and candidate cells, if the UE 802 receives multiple TCI activations for a set of serving and candidate cells at different time occasions, the UE 802 may maintain up to X activated TCIs for a subset of the cells based on configurations. In one aspect, the configuration for the UE 802 may be rule based, e.g., using a set of state list conditions, while in another aspect, the UE 802 may receive signaling, e.g., from the base station 804, for TCI maintenance/activation and/or deactivation for each cell, when the number of activated TCIs exceed X.

In the configuration 820, for a rule based configuration, the UE 802 may support a maximum number of concurrently active TCIs that corresponds to at least two concurrently active TCIs. The UE 802 may be configured to receive a first TCI state list 806 (e.g., of the TCI state list 508 in FIG. 5) at a different time occasion than a second TCI state list 808, such as prior to the second TCI state list 808, as shown. The UE 802 may be configured to maintain (at 810), subsequent to the switch from the serving cell to the target cell and based on the state list indication, the first TCI state list and the second TCI state list. In one example, the state list indication may be a set of state list conditions and may indicate maintenance of at most the maximum number of concurrently active TCIs that are most recently activated TCIs. In another example, the UE 802 may be configured to receive, and the base station 804 may be configured to provide/transmit, the state list indication (e.g., a state list indication 809) that indicates the maintenance of at most the maximum number of concurrently active TCIs that are most recently activated TCIs. That is, the cells for which TCI state lists are maintained may be the subset of cells with the latest TCI activation indications, for cells with newer TCI activations, and the UE 802 may implicitly replace cells with older TCI activations when the number of activated TCIs exceed X, noted above. One advantage of such a configuration is that it may save signaling for TCI deactivation between the UE 802 and the base station 804.

In aspects, by way of example, at least a third TCI state list 814 may be active at the UE 802 and, together with the first TCI state list 806 and the second TCI state list 808, the maximum number of concurrently active TCI state lists (e.g., X) may be exceeded. In aspects for the set of state list conditions, and for receiving the state list condition (e.g., dynamically from the base station 804), the UE 802 may be configured to replace (at 816) at least the third TCI state list that is active at the UE with at least one of the first TCI state list or the second TCI state list based on the third TCI state list having an activation time that is older than activation times of the most recently activated TCIs. In different aspects, a switching command, as similarly described above for the switching command 510 in FIG. 5 (e.g., subsequent to receiving one or more TCI state lists (TCI state list 508) that includes a first and a second TCI state list) may be received by the UE 502, and a switching command, as similarly described above for the switching command 612 in FIG. 6 (e.g., subsequent to receiving one or more TCI state lists (TCI state list 608) that includes a first and a second TCI state list) may be received by the UE 602. As noted above for FIG. 5, the UE 502 may be configured to activate (at 512), subsequent to a switch from a serving cell to a target cell and based on a state list indication, at least one of a first TCI state list associated with a cell configuration of the target cell at the UE 502 or a second TCI state list associated with mobility of the UE 502 for a target cell, while in FIG. 6, the UE 602 may be configured to activate (at 610), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. Subsequently, the UE 802 may exchange the communications 812 with the target base station, e.g., the base station 805, according to the activated TCIs.

From 1210, flowchart 1200 may continue to 1216.

At 1212, the UE determines if activation, maintenance, and/or deactivation of TCI state lists and TCIs is associated with a configuration for a target cell set and a maximum number of concurrently active TCIs. If so, flowchart 1200 continues to 1210; if not, flowchart 1200 continues to 1212. As an example, the reception may be performed by one or more of the component 198, the transceiver 1522, and/or the antenna 1580 in FIG. 15.

At 1214, the UE maintains or deactivates, subsequent to the switch from the serving cell to the target cell and based on the state list indication, a third TCI state list, where the UE supports a maximum number of concurrently active TCIs for a set of candidate cells, where the UE is configured to maintain a target number of concurrently active TCIs for the target cell, where the target cell is included in the set of candidate cells, and where receiving the second TCI state list comprises receiving a third TCI state list associated with a candidate cell configuration that is separate from the cell configuration of the target cell. As an example, the reception may be performed by one or more of the component 198, the transceiver 1522, and/or the antenna 1580 in FIG. 15. FIG. 9 illustrates an example of the UE 502 maintaining or deactivating the third TCI state list for mobility with reference to FIG. 5 (at 512).

The UE 902 may be associated with multiple candidate cells with activated TCIs, but only a subset of the multiple candidate cells may become target cells by a cell switch command(s). The remaining, non-selected cells may still remain as candidate cells, and the UE 902 may be configured to maintain/activate and/or deactivate the activated TCIs for the non-selected cells. For instance, and by way of example, in LTM, when the UE 902 supports X>1 activated TCIs in total for candidate cells, if the UE 902 desires or is configured to maintain Y activated TCIs for the new target cells after the cell switch command(s), the UE 902 may determine which X-Y (X minus Y) activated TCIs are to be maintained/kept in the non-selected candidate cells that are not switched on. In one aspect, the configuration for the UE 902 may be rule based, e.g., using a set of state list conditions, while in another aspect, the UE 902 may receive signaling, e.g., from the base station 904, for TCI maintenance/activation and/or deactivation for each cell, to maintain/keep the desired/configured X−Y (X minus Y) activated TCIs for the non-selected candidate cells. In the configuration shown for the diagram 900, for a rule based/implicit configuration, the UE 902 may support a maximum number of concurrently active TCIs for a set of candidate cells, which may include a target cell(s). The UE 902 may be configured to receive a first TCI state list 906 (e.g., of the TCI state list 508 in FIG. 5) and second and third TCI state lists 908, such as prior to, or at the same time as, the first TCI state list 906. The UE 902 may be configured to maintain or deactivate (at 910), subsequent to the switch from the serving cell to the target cell and based on the state list indication, the third TCI state list.

In one example, the state list indication may be a set of state list conditions and may indicate (1) a set of lowest TCI IDs to maintain and/or (2) maintenance of the target number of concurrently active TCIs for the target cell and deactivation for a remaining portion of active TCIs associated with the set of candidate cells. In another example, the UE 902 may be configured to receive, and the base station 904 may be configured to provide/transmit, the state list indication (e.g., a state list indication 914) that indicates (1) a separate TCI activation for the third TCI state list and/or (2) a subset of the candidate cells. That is, the UE 902 may be configured to utilize rule based/implicit configurations where X-Y (X minus Y) TCIs are activated for the first lowest ID candidate cells and/or implicit deactivation for all candidate cells not switched on after a cell switch command (e.g., where all TCI activations for candidate cells not switched on are deactivated by a cell switch command), which may save signaling for TCI deactivation between the UE 902 and the base station 904, and the UE 902 may be configured to utilize the state list indication 914, by signaling, for a new TCI activation(s) for each candidate cell (e.g., the UE 902 expects an explicit new TCI activation for each candidate cell) and/or a base station indication whereby the UE 902 may be indicated to maintain/keep TCIs activated for a subset of candidate cells.

In aspects, by way of example, at least a third TCI state list, which may be associated with a candidate cell configuration that is separate from the cell configuration of a target cell(s), may be received with a second TCI state list (e.g., the second and third TCI state lists 908). In aspects for the set of state list conditions, and for receiving the state list condition (e.g., dynamically from the base station 904), the UE 902 may be configured to maintain or deactivate (at 910) the third TCI state list (1) based on TCIs associated with the third TCI state list having TCI IDs in the set of lowest TCI IDs where the state list indication is the set of state list conditions that indicates a set of lowest TCI IDs, (2) based on the received state list activation indicates a separate TCI activation (which may indicate activation/deactivation) for the third TCI state list, (3) based on the set of state list conditions that is a set of state list conditions and that indicates maintenance of the target number of concurrently active TCIs for the target cell and deactivation for a remaining portion of active TCIs associated with the set of candidate cells, and/or (4) based on the third TCI state list being associated with a candidate cell included in the subset of the candidate cells that is indicated by the received state list activation.

In different aspects, a switching command, as similarly described above for the switching command 510 in FIG. 5 (e.g., subsequent to receiving one or more TCI state lists (TCI state list 508) that includes a first and a second TCI state list) may be received by the UE 502. As noted above for FIG. 5, the UE 502 may be configured to activate (at 512), subsequent to a switch from a serving cell to a target cell and based on a state list indication, at least one of a first TCI state list associated with a cell configuration of the target cell at the UE 502 or a second TCI state list associated with mobility of the UE 502 for a target cell. Aspects herein for the configuration in the diagram 900 contemplate the maintenance or deactivation (at 910) for the operations/functions described for the call flow diagram in FIG. 5. Subsequently, the UE 902 may exchange the communications 912 with the target base station, e.g., the base station 905, according to the activated TCIs.

At 1216, the UE exchanges communications with the target cell based on the first TCI state list and/or the second TCI state list. As an example, the reception may be performed by one or more of the component 198, the transceiver 1522, and/or the antenna 1580 in FIG. 15. FIG. 5 illustrates an example of the UE 502 communicating with the target cell (e.g., the base station 505).

The UE 502 may be configured, according to the state list indication (e.g., 712, 744 in FIG. 7; 809, 818 in FIG. 8; 914, 916 in FIG. 9), to transmit/provide and receive (e.g., exchange) communications 514 with the base station 505 based on the first and/or the second TCI state list of the TCI state list 508.

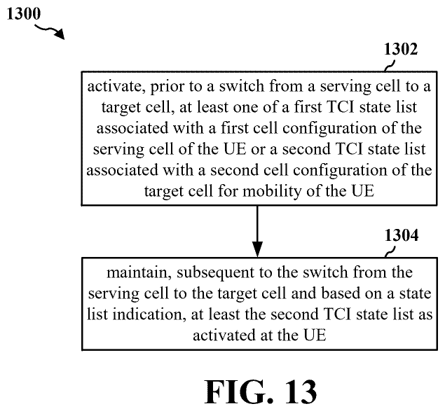

FIG. 13 is a flowchart 1300 of a method of wireless communication, in various aspects. The method may be performed by a UE (e.g., the UE 104, 402, 502, 602, 702, 802, 902, 1002; the apparatus 1504). In some aspects, the method may include aspects described in connection with the communication flow in FIG. 6 and/or aspects described in FIG. 7. The method may be for TCI before and after a cell switch command in a candidate cell and activated TCI selection for LTM, and provides improvements in UE mobility that enable a UE to utilize TCI state information before and after cell switching commands for LTM, where the TCI state information may be outside cell configurations, but after cell switch commands, and aspects provide for consolidation with cell configurations.

At 1302, the UE activates, prior to a switch from a serving cell to a target cell, at least one of a first TCI state list associated with a first cell configuration of the serving cell of the UE or a second TCI state list associated with a second cell configuration of the target cell for mobility of the UE. As an example, the activation may be performed by one or more of the component 198, the transceiver 1522, and/or the antenna 1580 in FIG. 15. FIG. 6 illustrates an example of the UE 602 activating a first TCI state list and/or a second TCI state list for mobility.

The UE 602 may be configured to receive, and the base station 604 may be configured to provide/transmit, a TCI state list 608 (also “TCI state list(s) 608), which may include one or more TCI state lists in aspects. In aspects, a TCI state list may include one or more TCIs for a cell, such as a serving cell (e.g., the base station 604), a candidate cell(s) (e.g., the base station 605 and/or other base stations not shown for illustrative clarity and brevity), and/or a target cell (e.g., the base station 605). In aspects, candidate cells may be cells to which the UE 602 may move using mobility/LTM, and a target cell(s) may be the cell(s) to which the UE 602 moves, where the target cell(s) becomes a new serving cell(s) after the mobility/LTM operations (e.g., after a handover). The TCI state list 608 may be provided as a “dl-OrJoint-TCIStateList” and/or an “ul-TCI-StateList,” in aspects. The TCI state list 608 may include one or more TCI state lists that are provided together, provided separately, provided concurrently, and/or provided at different time occasions. One or more TCIs of the TCI state list 608 may each include a numeric TCI ID from a TCI ID pool. In aspects, each TCI of the TCI state list 608 may have a unique TCI ID, while each TCI state list 608 may include TCIs that have a same TCI ID.

In some aspects, the TCI state list 608 may be provided/transmitted to, and received by, the UE 602 prior to receiving a switching command 612, e.g., for LTM, from the base station 604 for the UE 602 to switch to the base station 605, and the switching command 612 may be received by the UE 602 subsequent to activation of at least one TCI at the UE 602. The UE 602 may be configured to activate (at 610) (e.g., at 708, at 742 in FIG. 7), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. That is, before the switch from the base station 604 to the base station 605, the UE 602 may activate (at 610) (e.g., at 708, at 742 in FIG. 7) ones of the TCI state list 608 associated with a cell configuration of the base station 604 (e.g., the serving cell) at the UE 602 and/or associated with ones of the TCI state list 608 associated with mobility of the UE 602 for the base station 505 (e.g., the target cell) based on the state list indication (e.g., 712, 744 in FIG. 7).

At 1304, the UE maintains, subsequent to the switch from the serving cell to the target cell and based on a state list indication, at least the second TCI state list as activated at the UE. As an example, the maintenance may be performed by one or more of the component 198, the transceiver 1522, and/or the antenna 1580 in FIG. 15. FIG. 6 illustrates an example of the UE 602 maintaining at least the second TCI state list for mobility.

After the cell switch triggered by the switching command 612, the UE 602 may be configured to maintain (at 614), subsequent to the switch from the serving cell to the target cell and based on a state list indication (e.g., 712, 744 in FIG. 7), at least the second TCI state list as activated at the UE. That is, after the switch from the base station 604 to the base station 605, the UE 602 may maintain (at 614), from the TCI state list 608, activation of the TCI(s) associated with the cell configuration of the base station 605 (e.g., the target cell) at the UE 602, and the UE 602 may also be configured to maintain (at 614) or deactivate, from the TCI state list 608, the activated TCI(s) associated with the mobility/LTM of the UE 602 for the base station 604 (e.g., the serving cell).

The UE 602 may be configured, according to the state list indication (e.g., 712, 744 in FIG. 7), to transmit/provide and receive (e.g., exchange) communications 616 with the base station 605 based on the second TCI state list, and may be configured to maintain or deactivate the first TCI state list of the TCI state list 608. In aspects, the state list indication (e.g., 712, 744 in FIG. 7) may be a set of state list conditions, stored/maintained at the UE 602, based on pre-configuration, based on a communication from the base station 604, and/or the like. In aspects, the state list indication (e.g., 712, 744 in FIG. 7) may be provided to the UE 602 dynamically by the base station 604.

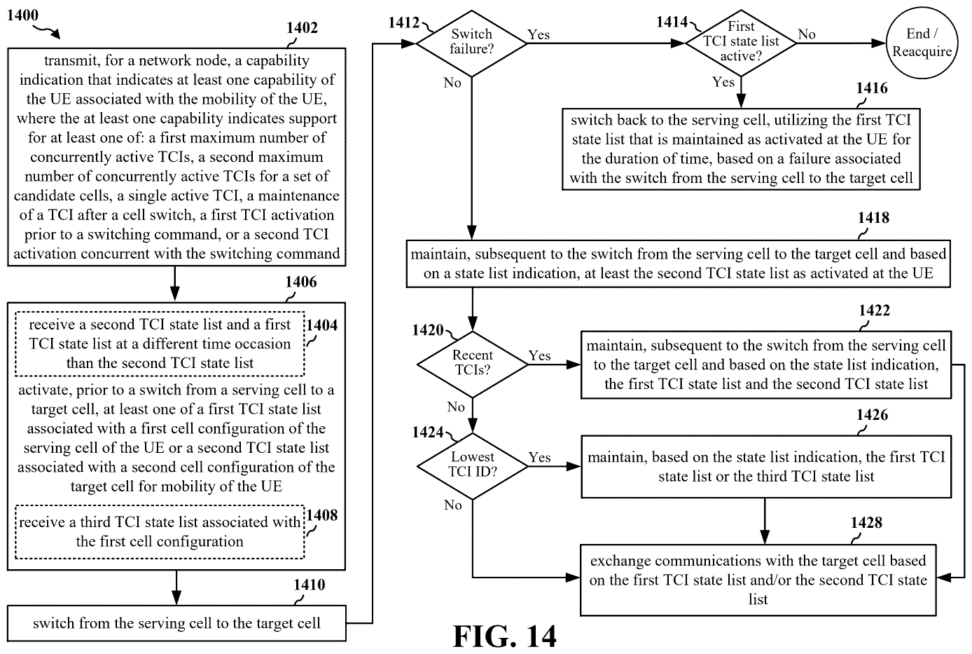

FIG. 14 is a flowchart 1400 of a method of wireless communication, in various aspects. The method may be performed by a UE (e.g., the UE 104, 402, 502, 602, 702, 802, 902, 1002; the apparatus 1504). In some aspects, the method may include aspects described in connection with the communication flow in FIG. 6 and/or aspects described in FIG. 7, 8, 10. The method may be for TCI before and after a cell switch command in a candidate cell and activated TCI selection for LTM, and provides improvements in UE mobility that enable a UE to utilize TCI state information before and after cell switching commands for LTM, where the TCI state information may be outside cell configurations, but after cell switch commands, and aspects provide for consolidation with cell configurations.

At 1402, the UE transmits/provides, for a network node, a capability indication that indicates at least one capability of the UE associated with the mobility of the UE, where the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command. As an example, the transmission/provision may be performed by one or more of the component 198, the transceiver 1522, and/or the antenna 1580 in FIG. 15. FIG. 6 illustrates an example of the UE 602 transmitting/providing the capability indication for mobility to a network node (e.g., the base station 604 as a serving cell).

The UE 602 may be configured to provide/transmit, and the base station 604 may be configured to receive, a capability indication 606. The capability indication 606 may indicate at least one capability of the UE 602 associated with the mobility (e.g., LTM) of the UE 602. The at least one capability may indicate support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

At 1404, the UE receives a second TCI state list and a first TCI state list at a different time occasion than the second TCI state list. As an example, the reception may be performed by one or more of the component 198, the transceiver 1522, and/or the antenna 1580 in FIG. 15. FIG. 6 illustrates an example of the UE 602 receiving a first TCI state list and a second TCI state list for mobility from a network node (e.g., the base station 604 as a serving cell).

The UE 602 may be configured to receive, and the base station 604 may be configured to provide/transmit, a TCI state list 608 (also “TCI state list(s) 608), which may include one or more TCI state lists in aspects. The TCI state list 608 may include one or more TCI state lists that are provided together, provided separately, provided concurrently, and/or provided at different time occasions. In some aspects, 1404 may not be performed when the second and first TCI state lists are received together.

At 1406, the UE activates, prior to a switch from a serving cell to a target cell, at least one of a first TCI state list associated with a first cell configuration of the serving cell of the UE or a second TCI state list associated with a second cell configuration of the target cell for mobility of the UE. As an example, the activation may be performed by one or more of the component 198, the transceiver 1522, and/or the antenna 1580 in FIG. 15. FIG. 6 illustrates an example of the UE 602 activating a first TCI state list and/or a second TCI state list for mobility.

The UE 602 may be configured to receive, and the base station 604 may be configured to provide/transmit, a TCI state list 608 (also “TCI state list(s) 608), which may include one or more TCI state lists in aspects. In aspects, a TCI state list may include one or more TCIs for a cell, such as a serving cell (e.g., the base station 604), a candidate cell(s) (e.g., the base station 605 and/or other base stations not shown for illustrative clarity and brevity), and/or a target cell (e.g., the base station 605). In aspects, candidate cells may be cells to which the UE 602 may move using mobility/LTM, and a target cell(s) may be the cell(s) to which the UE 602 moves, where the target cell(s) becomes a new serving cell(s) after the mobility/LTM operations (e.g., after a handover). The TCI state list 608 may be provided as a “dl-OrJoint-TCIStateList” and/or an “ul-TCI-StateList,” in aspects. The TCI state list 608 may include one or more TCI state lists that are provided together, provided separately, provided concurrently, and/or provided at different time occasions. One or more TCIs of the TCI state list 608 may each include a numeric TCI ID from a TCI ID pool. In aspects, each TCI of the TCI state list 608 may have a unique TCI ID, while each TCI state list 608 may include TCIs that have a same TCI ID.

In some aspects, the TCI state list 608 may be provided/transmitted to, and received by, the UE 602 prior to receiving a switching command 612, e.g., for LTM, from the base station 604 for the UE 602 to switch to the base station 605, and the switching command 612 may be received by the UE 602 subsequent to activation of at least one TCI at the UE 602. The UE 602 may be configured to activate (at 610) (e.g., at 708, at 742 in FIG. 7), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. That is, before the switch from the base station 604 to the base station 605, the UE 602 may activate (at 610) (e.g., at 708, at 742 in FIG. 7) ones of the TCI state list 608 associated with a cell configuration of the base station 604 (e.g., the serving cell) at the UE 602 and/or associated with ones of the TCI state list 608 associated with mobility of the UE 602 for the base station 505 (e.g., the target cell) based on the state list indication (e.g., 712, 744 in FIG. 7).

At 1408, the UE receives a third TCI state list associated with the first cell configuration. As an example, the reception may be performed by one or more of the component 198, the transceiver 1522, and/or the antenna 1580 in FIG. 15. FIG. 6 illustrates an example of the UE 602 receiving a third TCI state list (e.g., TCI state list 608) for mobility from a network node (e.g., the base station 604 as a serving cell).

Additionally, with respect to FIG. 8, at least a third TCI state list 814 may be active at the UE 802 and, together with the first TCI state list 806 and the second TCI state list 808, the maximum number of concurrently active TCI state lists (e.g., X) may be exceeded. The third TCI state list may be received by the UE 802 together with or separate from the first and second TCI set lists as transmitted/provided by the base station 804. In some aspects, 1408 may not be performed when the third TCI state list is not received.

At 1410, the UE switches from the serving cell to the target cell. As an example, the switch may be performed by one or more of the component 198, the transceiver 1522, and/or the antenna 1580 in FIG. 15. FIG. 6 illustrates an example of the UE 602 switching to the target cell using mobility.

In some aspects, the TCI state list 608 may be provided/transmitted to, and received by, the UE 602 prior to receiving a switching command 612, e.g., for LTM, from the base station 604 for the UE 602 to switch (e.g., 1062 in FIG. 10) to the base station 605, and the switching command 612 may be received by the UE 602 subsequent to activation of at least one TCI at the UE 602. The UE 602 may be configured to activate (at 610) (e.g., at 708, at 742 in FIG. 7), prior to a switch (e.g., 1062 in FIG. 10) from a serving cell to a target cell, e.g., based on the switching command 612, at least one of a first TCI state list associated with a first cell configuration of the serving cell of the UE or a second TCI state list associated with a second cell configuration of the target cell for mobility of the UE 602.

At 1412, the UE determines if there is a switch failure. If there is a failure (e.g., 1064 in FIG. 10) associated with the target cell, flowchart 1400 continues to 1414; if not, flowchart 1400 continues to 1418. As an example, the maintenance may be performed by one or more of the component 198, the transceiver 1522, and/or the antenna 1580 in FIG. 15. FIG. 10 illustrates an example of the UE 1002 experiencing a failure for mobility to a target cell.

The configuration 1060 illustrates a failure for a switch of the UE 1002 from the base station 1004 to the base station 1005, in the context of the configuration 1020 where maintenance (e.g., at 1006) of the first TCI state list for the base station 1004 is performed by the UE 1002. For instance, the UE 1002 may be configured to maintain (e.g., at 1006) of the first TCI state list for the base station 1004, and based on the switching command 1008, the UE 1002 may switch (at 1062) to the base station 1005. That is, the UE 1002 may be configured to switch from the serving cell to the target cell. In aspects, during or subsequent to the switch (at 1062), a failure 1064 associated with the switch (at 1062) from the base station 1004 to the base station 1005 may occur by or within the duration of time for which the UE 1002 has maintained (e.g., at 1006) the first TCI state for the base station 1004.

At 1414, the UE determines if the first TCI state list remains active. If so, flowchart 1400 continues to 1416; if not, flowchart 1400 may end and/or the UE may reacquire a serving cell. As an example, the determination for active maintenance may be performed by one or more of the component 198, the transceiver 1522, and/or the antenna 1580 in FIG. 15. FIG. 10 illustrates an example of the UE 1002 maintaining the first TCI state list as active.

In the configuration 1020 of diagram 1000, for a rule based configuration, the UE 1002 may support X>1 active TCIs. The UE 1002 may be configured to maintain (at 1006) the first TCI state list as activated at the UE 1002 based on the set of state list conditions. In other words, the UE 1002 may be configured to maintain (at 1006) the activated TCIs for the source cell over a time duration after the cell switch. The UE 1002 may be configured to receive the first and second TCI state lists (not shown for brevity and illustrative clarity; e.g., of the TCI state list 508 in FIG. 5) at a different time occasions or the same time occasion, prior to the maintenance (at 1006). The UE 1002 may be configured to receive a switching command 1008, as similarly described above for the switching command 612 in FIG. 6 (e.g., subsequent to receiving one or more TCI state lists (TCI state list 608) that include a first and a second TCI state list and subsequent to the maintenance (at 1006)) and switch to the base station 1005 while maintaining the activated TCI(s) of the first TCI state list for a configured duration of time. In aspects, this may be advantageous for the UE 1002 to more efficiently switch back to the base station 1004 (e.g., the original serving cell) if the switch to the base station 1005 (e.g., the target cell) fails for any reason. In one example, the state list indication may be a set of state list conditions and may indicate that (1) the first TCI state list and the second TCI state list comprise a same TCI ID pool and have different TCI ID subsets of the TCI ID pool and/or that (2) the first TCI state list is a subset of the second TCI state list. Where the properties/characteristics of the first TCI state list meet at least one of the state list conditions, the UE 1002 may be configured to maintain (at 1006) the first TCI state list for the base station 1004.

At 1416, the UE switches back to the serving cell, utilizing the first TCI state list that is maintained as activated at the UE for the duration of time, based on a failure associated with the switch from the serving cell to the target cell. As an example, the switching may be performed by one or more of the component 198, the transceiver 1522, and/or the antenna 1580 in FIG. 15. FIG. 10 illustrates an example of the UE 1002 switching back to the serving cell (e.g., the base station 1004).

The UE may be configured to switch (at 1066) back to the base station 1004, utilizing the first TCI state list that is maintained (e.g., at 1006) as activated at the UE 1002 for the duration of time, based on the failure 1064 associated with the switch (at 1062) from the base station 1004 to the base station 1005. In aspects, the duration of time may be configured by the UE 1002 and/or the base station 1004 (e.g., as a characteristic/parameter of the first TCI state list, as a list condition of the set of state list conditions, etc.). Accordingly, the UE 1002 may be configured to switch back to the serving cell, utilizing the first TCI state list that is maintained as activated at the UE for the duration of time, based on a failure associated with the switch from the serving cell to the target cell. As noted above, maintenance (e.g., at 1006) of the first TCI state list for the base station 1004 may be advantageous for the UE 1002 to more efficiently switch back to the base station 1004 (e.g., the original serving cell) if the switch to the base station 1005 (e.g., the target cell) fails for any reason.

At 1418, the UE maintains, subsequent to the switch from the serving cell to the target cell and based on a state list indication, at least the second TCI state list as activated at the UE. As an example, the maintenance may be performed by one or more of the component 198, the transceiver 1522, and/or the antenna 1580 in FIG. 15. FIG. 6 illustrates an example of the UE 602 maintaining at least the second TCI state list for mobility.

After the cell switch triggered by the switching command 612, the UE 602 may be configured to maintain (at 614), subsequent to the switch from the serving cell to the target cell and based on a state list indication (e.g., 712, 744 in FIG. 7), at least the second TCI state list as activated at the UE. That is, after the switch from the base station 604 to the base station 605, the UE 602 may maintain (at 614), from the TCI state list 608, activation of the TCI(s) associated with the cell configuration of the base station 605 (e.g., the target cell) at the UE 602, and the UE 602 may also be configured to maintain (at 614) or deactivate, from the TCI state list 608, the activated TCI(s) associated with the mobility/LTM of the UE 602 for the base station 604 (e.g., the serving cell).

The UE 602 may be configured, according to the state list indication (e.g., 712, 744 in FIG. 7), to transmit/provide and receive (e.g., exchange) communications 616 with the base station 605 based on the second TCI state list, and may be configured to maintain or deactivate the first TCI state list of the TCI state list 608. In aspects, the state list indication (e.g., 712, 744 in FIG. 7) may be a set of state list conditions, stored/maintained at the UE 602, based on pre-configuration, based on a communication from the base station 604, and/or the like. In aspects, the state list indication (e.g., 712, 744 in FIG. 7) may be provided to the UE 602 dynamically by the base station 604.

At 1420, the UE determines if activation, maintenance, and/or deactivation of TCI state lists and TCIs is associated with a configuration for recent TCIs and/or a maximum number of concurrently active TCIs. If so, flowchart 1400 continues to 1422; if not, flowchart 1400 continue to 1424. As an example, the determining may be performed by one or more of the component 198, the transceiver 1522, and/or the antenna 1580 in FIG. 15.

At 1422, the UE maintains, subsequent to the switch from the serving cell to the target cell and based on the state list indication, the first TCI state list and the second TCI state list. As an example, the maintenance may be performed by one or more of the component 198, the transceiver 1522, and/or the antenna 1580 in FIG. 15. FIG. 8 illustrates an example of the UE 1002 maintaining the first TCI state list and the second TCI state list as active.

The UE 802 may be configured to receive TCI activations for multiple serving and/or candidate cells at different time occasions, and if the total number of activated TCIs exceeds the UE 802 capability, down selection of the TCIs/TCI state lists may be utilized by the UE 802. For instance, and by way of example, in LTM, when the UE 802 supports X>1 activated TCIs in total for both serving and candidate cells, if the UE 802 receives multiple TCI activations for a set of serving and candidate cells at different time occasions, the UE 802 may maintain up to X activated TCIs for a subset of the cells based on configurations. In one aspect, the configuration for the UE 802 may be rule based, e.g., using a set of state list conditions, while in another aspect, the UE 802 may receive signaling, e.g., from the base station 804, for TCI maintenance/activation and/or deactivation for each cell, when the number of activated TCIs exceed X.

In the configuration 820, for a rule based configuration, the UE 802 may support a maximum number of concurrently active TCIs that corresponds to at least two concurrently active TCIs. The UE 802 may be configured to receive a first TCI state list 806 (e.g., of the TCI state list 508 in FIG. 5) at a different time occasion than a second TCI state list 808, such as prior to the second TCI state list 808, as shown. The UE 802 may be configured to maintain (at 810), subsequent to the switch from the serving cell to the target cell and based on the state list indication, the first TCI state list and the second TCI state list. In one example, the state list indication may be a set of state list conditions and may indicate maintenance of at most the maximum number of concurrently active TCIs that are most recently activated TCIs. In another example, the UE 802 may be configured to receive, and the base station 804 may be configured to provide/transmit, the state list indication (e.g., a state list indication 809) that indicates the maintenance of at most the maximum number of concurrently active TCIs that are most recently activated TCIs. That is, the cells for which TCI state lists are maintained may be the subset of cells with the latest TCI activation indications, for cells with newer TCI activations, and the UE 802 may implicitly replace cells with older TCI activations when the number of activated TCIs exceed X, noted above. One advantage of such a configuration is that it may save signaling for TCI deactivation between the UE 802 and the base station 804.

In aspects, by way of example, at least a third TCI state list 814 may be active at the UE 802 and, together with the first TCI state list 806 and the second TCI state list 808, the maximum number of concurrently active TCI state lists (e.g., X) may be exceeded. In aspects for the set of state list conditions, and for receiving the state list condition (e.g., dynamically from the base station 804), the UE 802 may be configured to replace (at 816) at least the third TCI state list that is active at the UE with at least one of the first TCI state list or the second TCI state list based on the third TCI state list having an activation time that is older than activation times of the most recently activated TCIs. In different aspects, a switching command, as similarly described above for the switching command 510 in FIG. 5 (e.g., subsequent to receiving one or more TCI state lists (TCI state list 508) that includes a first and a second TCI state list) may be received by the UE 502, and a switching command, as similarly described above for the switching command 612 in FIG. 6 (e.g., subsequent to receiving one or more TCI state lists (TCI state list 608) that includes a first and a second TCI state list) may be received by the UE 602. As noted above for FIG. 5, the UE 502 may be configured to activate (at 512), subsequent to a switch from a serving cell to a target cell and based on a state list indication, at least one of a first TCI state list associated with a cell configuration of the target cell at the UE 502 or a second TCI state list associated with mobility of the UE 502 for a target cell, while in FIG. 6, the UE 602 may be configured to activate (at 610), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. Subsequently, the UE 802 may exchange the communications 812 with the target base station, e.g., the base station 805, according to the activated TCIs.

At 1424, UE determines if activation, maintenance, and/or deactivation of TCI state lists and TCIs is associated with a configuration for TCI IDs and/or a maximum number of concurrently active TCIs. If so, flowchart 1400 continues to 1426; if not, flowchart 1400 continue to 1428. As an example, the determining may be performed by one or more of the component 198, the transceiver 1522, and/or the antenna 1580 in FIG. 15.

At 1426, the UE maintains, based on the state list indication, the first TCI state list or the third TCI state list. As an example, the reception may be performed by one or more of the component 198, the transceiver 1522, and/or the antenna 1580 in FIG. 15. FIG. 8 illustrates an example of the UE 802 maintaining the first or the third TCI state list for mobility.

In the configuration 840, for a rule based configuration, the UE 802 may support a maximum number of concurrently active TCIs that corresponds to at least two concurrently active TCIs. The UE 802 may be configured to receive a first and third TCI state list 806′ (e.g., of the TCI state list 508 in FIG. 5) and the second TCI state list 808, such as concurrently with or after (e.g., at a different time occasion) the first and third TCI state list 806′. The UE 802 may be configured to maintain (at 842), based on the state list indication, the first TCI state list or the third TCI state list.

In one example, the state list indication may be a set of state list conditions and may indicate maintenance of up to the maximum number of concurrently active TCIs associated with the serving cell based on a number of concurrently active TCIs associated with the target cell. In another example, the UE 802 may be configured to receive, and the base station 804 may be configured to provide/transmit, the state list indication (e.g., a state list indication 841) that indicates the maintenance of up to the maximum number of concurrently active TCIs associated with the serving cell based on a number of concurrently active TCIs associated with the target cell. That is, the cells for which TCI state lists are maintained may have the first X-Y (X minus Y) lowest TCI IDs activated for the serving cell, and the UE 802 may keep these TCIs active/activated (e.g., maintained), while in aspects, the higher TCIs may not be maintained and/or may be deactivated/replaced. One advantage of such a configuration is that it may save signaling for TCI deactivation between the UE 802 and the base station 804.

In aspects, by way of example, first and third TCI state lists 844 may be active at the UE 802 and, together with the second TCI state list 808, and any other active TCIs in TCI state lists not shown for brevity and clarity, the maximum number of concurrently active TCI state lists (e.g., X) for serving and candidate cells may be exceeded. In aspects for the set of state list conditions, and for receiving the state list condition (e.g., dynamically from the base station 804), the UE 802 may be configured to maintain (at 846) the first TCI state list or the third TCI state list based on the received state list indication, and deactivate another of first TCI state list and the third TCI state list based on the received state list indication.

In different aspects, a switching command, as similarly described above for the switching command 510 in FIG. 5 (e.g., subsequent to receiving one or more TCI state lists (TCI state list 508) that includes a first and a second TCI state list). As noted above for FIG. 5, the UE 502 may be configured to activate (at 512), subsequent to a switch from a serving cell to a target cell and based on a state list indication, at least one of a first TCI state list associated with a cell configuration of the target cell at the UE 502 or a second TCI state list associated with mobility of the UE 502 for a target cell, while in FIG. 6, the UE 602 may be configured to activate (at 610), prior to a switch from a serving cell to a target cell, e.g., based on the switching command 612, at least one of a first TCI state list associated with a first cell configuration of the serving cell of the UE or a second TCI state list associated with a second cell configuration of the target cell for mobility of the UE 602. Subsequently, the UE 802 may exchange the communications 812 with the target base station, e.g., the base station 805, according to the activated TCIs.

At 1428, the UE exchanges communications with the target cell based on the first TCI state list and/or the second TCI state list. As an example, the reception may be performed by one or more of the component 198, the transceiver 1522, and/or the antenna 1580 in FIG. 15. FIG. 6 illustrates an example of the UE 602 communicating with the target cell (e.g., the base station 605).

The UE 602 may be configured, according to the state list indication (e.g., 712, 744 in FIG. 7; 809, 818 in FIG. 8; 914, 916 in FIG. 9), to transmit/provide and receive (e.g., exchange) communications 616 with the base station 605 based on the first and/or the second TCI state list of the TCI state list 608.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to receive, from a network node, a second TCI state list associated with mobility of the UE for a target cell. The component 198 may also be configured to activate, subsequent to a switch from a serving cell to the target cell and based on a state list indication, at least one of a first TCI state list associated with a cell configuration of the target cell at the UE or the second TCI state list. The component 198 may be configured to maintain, subsequent to the switch from the serving cell to the target cell and based on the state list indication, the first TCI state list and the second TCI state list. The component 198, to receive the second TCI state list, may be configured to receive a third TCI state list associated with a candidate cell configuration that is separate from the cell configuration of the target cell, and may be configured to maintain or deactivate, subsequent to the switch from the serving cell to the target cell and based on the state list indication, the third TCI state list. The component 198 may be configured to activate, prior to a switch from a serving cell to a target cell, at least one of a first TCI state list associated with a first cell configuration of the serving cell of the UE or a second TCI state list associated with a second cell configuration of the target cell for mobility of the UE. The component 198 may also be configured to maintain, subsequent to the switch from the serving cell to the target cell and based on a state list indication, at least the second TCI state list as activated at the UE. The component 198 may be configured to switch from the serving cell to the target cell. The component 198 may be configured to switch back to the serving cell, utilizing the first TCI state list that is maintained as activated at the UE for the duration of time, based on a failure associated with the switch from the serving cell to the target cell. The component 198 may be configured to receive the second TCI state list and the first TCI state list at a different time occasion than the second TCI state list. The component 198 may be configured to maintain, subsequent to the switch from the serving cell to the target cell and based on the state list indication, the first TCI state list and the second TCI state list. The component 198, where a third TCI state list associated with the first cell configuration is received, may be configured to maintain, based on the state list indication, the first TCI state list or the third TCI state list. The component 198 may be configured to transmit, for the network node, a capability indication that indicates at least one capability of the UE associated with the mobility of the UE, where the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command. The component 198 may be further configured to perform any of the aspects described in connection with the flowchart in any of FIGS. 11-14, and/or any of the aspects performed by the UE in any of FIGS. 4-10. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, from a network node, a second TCI state list associated with mobility of the UE for a target cell. In the configuration, the apparatus 1504, and in particular the cellular baseband processor(s) 1524 and/or the application processor(s) 1506, may include means for activating, subsequent to a switch from a serving cell to the target cell and based on a state list indication, at least one of a first TCI state list associated with a cell configuration of the target cell at the UE or the second TCI state list. In one configuration, the apparatus 1504, and in particular the cellular baseband processor(s) 1524 and/or the application processor(s) 1506, may include means for maintaining, subsequent to the switch from the serving cell to the target cell and based on the state list indication, the first TCI state list and the second TCI state list. In one configuration, the apparatus 1504, and in particular the cellular baseband processor(s) 1524 and/or the application processor(s) 1506, may include means for receiving the second TCI state list by receiving a third TCI state list associated with a candidate cell configuration that is separate from the cell configuration of the target cell, and may include means for maintaining or deactivating, subsequent to the switch from the serving cell to the target cell and based on the state list indication, the third TCI state list. In one configuration, the apparatus 1504, and in particular the cellular baseband processor(s) 1524 and/or the application processor(s) 1506, may include means for activating, prior to a switch from a serving cell to a target cell, at least one of a first TCI state list associated with a first cell configuration of the serving cell of the UE or a second TCI state list associated with a second cell configuration of the target cell for mobility of the UE. In the configuration, the apparatus 1504, and in particular the cellular baseband processor(s) 1524 and/or the application processor(s) 1506, may include means for maintaining, subsequent to the switch from the serving cell to the target cell and based on a state list indication, at least the second TCI state list as activated at the UE. In one configuration, the apparatus 1504, and in particular the cellular baseband processor(s) 1524 and/or the application processor(s) 1506, may include means for switching from the serving cell to the target cell. In one configuration, the apparatus 1504, and in particular the cellular baseband processor(s) 1524 and/or the application processor(s) 1506, may include means for switching back to the serving cell, utilizing the first TCI state list that is maintained as activated at the UE for the duration of time, based on a failure associated with the switch from the serving cell to the target cell. In one configuration, the apparatus 1504, and in particular the cellular baseband processor(s) 1524 and/or the application processor(s) 1506, may include means for receiving the second TCI state list and the first TCI state list at a different time occasion than the second TCI state list. In one configuration, the apparatus 1504, and in particular the cellular baseband processor(s) 1524 and/or the application processor(s) 1506, may include means for maintaining, subsequent to the switch from the serving cell to the target cell and based on the state list indication, the first TCI state list and the second TCI state list. In one configuration, the apparatus 1504, and in particular the cellular baseband processor(s) 1524 and/or the application processor(s) 1506, may include means for receiving a third TCI state list associated with the first cell configuration, and may include means for maintaining, based on the state list indication, the first TCI state list or the third TCI state list. In one configuration, the apparatus 1504, and in particular the cellular baseband processor(s) 1524 and/or the application processor(s) 1506, may include means for transmitting, for the network node, a capability indication that indicates at least one capability of the UE associated with the mobility of the UE, where the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

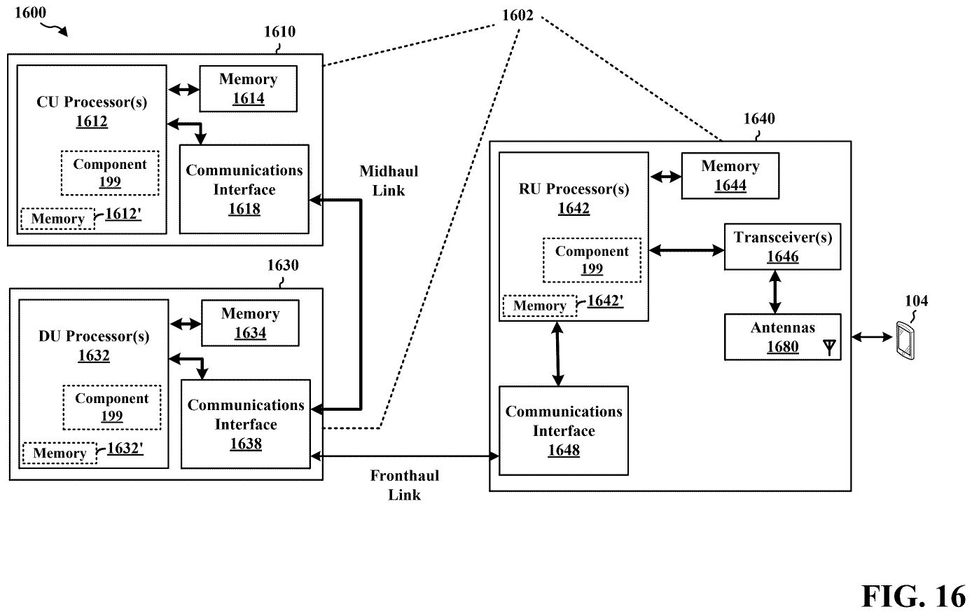

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to operate in accordance with the component 198 for network side operations/functions. The component 199 may be further configured to perform any of the aspects described in connection with the flowchart in any of FIGS. 11-14, and/or any of the aspects performed by the base stations/cells in any of FIGS. 4-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for operating in accordance with the component 198 for network side operations/functions. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

UE mobility may be LTM in which an associated cell for a UE may be updated using L1/L2 signaling from a network to a UE. The updates may be based on an L1 measurements (e.g., intra- and/or inter-frequency measurements). As an example, a UE may be initially served by one or more serving cells, which may include a special cell (SpCell) and/or one or more secondary cells (Cells), while candidate cells may be available to the UE for LTM. An SpCell may be a primary cell (PCell) or a primary secondary cell (PSCell). The UE may receive LTM communications from the serving cell for a move, using LTM, to a target cell, e.g., one of the candidate cells, as a new serving cell. The UE may then move to the target cell and initiate communications therewith (e.g., configurations for beams, a transmission configuration indication (TCI), a random access channel (RACH), etc.). However, TCI state activation of a candidate and/or target cell may be received before the reception of a beam indication(s) of the candidate and/or target cell, in some scenarios, while the TCI state activation of a candidate and/or target cell may be received together with the reception of beam indication of the candidate and/or target cell, in other scenarios. These two scenarios may also both be supported based on the capability(ies) of the moving UE, which may entail various beam indication and/or TCI activation timing relationships. When TCI state lists are used before cell switching, the TCI state lists may be used before, or together with, the cell switch command, and such TCI state lists may be configured external to configurations of both source/serving cell and target/candidate cells. Yet, when TCI state lists are used after cell switching, the TCI state lists may be used after a cell switching command and can be configured inside the target/candidate cell configuration. Thus, the relationship between these two TCI state list scenarios may impose complexity and timing issues. Likewise, a UE may receive TCI activations for multiple serving/candidate cells at different time occasions, and/or a UE may receive TCI activations for candidate cells when the UE has already been activated with a TCI for a serving cell. If the total number of activated TCIs exceeds the UE capability, the UE may not be configured to efficiently handle such a case. Similarly, when multiple candidate cells have activated TCIs, but only a subset thereof becomes a target cell(s) by a cell switch command(s), the remaining, non-selected cells are still candidate cells, and the UE may not be configured to efficiently handle such a case.

Various aspects herein for TCI before and after a cell switch command in a candidate cell and activated TCI selection for LTM may can be used to enable a UE to manage TCI state lists that are used before, or together with, cell switch commands where the TCI state lists are configured external to configurations of both source/serving cell and target/candidate cells, and that are used after cell switching commands where the TCI state lists are configured inside target/candidate cell configurations, by adaptively configuring a UE for TCI state lists before and after cell switching commands. Such aspects also may allow a UE to receive TCI activations for multiple serving and candidate cells at different time occasions by enabling the UE to perform down selection of activated TCIs. Aspects herein may also enable a UE to support activated TCIs for the target cell(s) by configuring the UE to maintain or deactivate non-selected, candidate cell TCI activations after a target cell(s) is selected based on the UE capability.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, a second transmission configuration indication (TCI) state list associated with mobility of the UE for a target cell; and activating, subsequent to a switch from a serving cell to the target cell and based on a state list indication, at least one of a first TCI state list associated with a cell configuration of the target cell at the UE or the second TCI state list.

Aspect 2 is the method of aspect 1, wherein the state list indication is a set of state list conditions, wherein activating at least one of the first TCI state list or the second TCI state list comprises: activating the first TCI state list and the second TCI state list simultaneously based on the set of state list conditions.

Aspect 3 is the method of aspect 2, wherein the first TCI state list and the second TCI state list comprise a same TCI identifier (ID) pool and have different TCI ID subsets of the TCI ID pool; or wherein the first TCI state list is a subset of the second TCI state list.

Aspect 4 is the method of aspect 1, wherein the state list indication is a set of state list conditions, wherein activating at least one of the first TCI state list or the second TCI state list comprises: activating the second TCI state list by replacing the first TCI state list.

Aspect 5 is the method of aspect 4, wherein the mobility of the UE for the target cell is Layer 1/Layer 2 (L1/L2) triggered mobility (LTM), wherein the UE replaces the first TCI state list based on its association with the LTM.

Aspect 6 is the method of any of aspects 1 to 5, wherein the second TCI state list is present at the UE prior to receiving the first TCI state list.

Aspect 7 is the method of any of aspects 1 to 6, wherein the UE supports a maximum number of concurrently active TCIs, wherein the maximum number of concurrently active TCIs corresponds to at least two concurrently active TCIs, and wherein receiving the second TCI state list comprises receiving the first TCI state list at a different time occasion than the second TCI state list; the method further comprising: maintaining, subsequent to the switch from the serving cell to the target cell and based on the state list indication, the first TCI state list and the second TCI state list.

Aspect 8 is the method of aspect 7, wherein the state list indication is a set of state list conditions, maintained at the UE, which indicates maintenance of at most the maximum number of concurrently active TCIs that are most recently activated TCIs, wherein the first TCI state list and the second TCI state list are included in the most recently activated TCIs; or wherein maintaining the first TCI state list and the second TCI state list comprises: receiving, from the network node, the state list indication, and maintaining the first TCI state list and the second TCI state list based on the received state list indication.

Aspect 9 is the method of aspect 8, wherein maintaining the first TCI state list and the second TCI state list comprises replacing at least a third TCI state list that is active at the UE with at least one of the first TCI state list or the second TCI state list based on the third TCI state list having an activation time that is older than activation times of the most recently activated TCIs.

Aspect 10 is the method of any of aspects 1 to 6, wherein the UE supports a maximum number of concurrently active TCIs for a set of candidate cells, wherein the UE is configured to maintain a target number of concurrently active TCIs for the target cell, wherein the target cell is included in the set of candidate cells, and wherein receiving the second TCI state list comprises receiving a third TCI state list associated with a candidate cell configuration that is separate from the cell configuration of the target cell; the method further comprising: maintaining or deactivating, subsequent to the switch from the serving cell to the target cell and based on the state list indication, the third TCI state list.

Aspect 11 is the method of aspect 10, wherein the state list indication is a set of state list conditions that indicates a set of lowest TCI identifiers (IDs), and wherein maintaining or deactivating the third TCI state list comprises: maintaining or deactivating the third TCI state list based on TCIs associated with the third TCI state list having TCI IDs in the set of lowest TCI IDs.

Aspect 12 is the method of aspect 10, wherein the state list indication indicates a separate TCI activation for the third TCI state list, wherein maintaining or deactivating the third TCI state list comprises: receiving, from the network node, the state list indication; and maintaining or deactivating the third TCI state list based on the received state list activation.

Aspect 13 is the method of aspect 10, wherein the state list indication is a set of state list conditions that indicates maintenance of the target number of concurrently active TCIs for the target cell and deactivation for a remaining portion of active TCIs associated with the set of candidate cells, and wherein maintaining or deactivating the third TCI state list comprises: maintaining or deactivating the third TCI state list based on the set of state list conditions.

Aspect 14 is the method of aspect 10, wherein the state list indication indicates a subset of the candidate cells, wherein maintaining or deactivating the third TCI state list comprises: receiving, from the network node, the state list indication; and maintaining or deactivating the third TCI state list based on the third TCI state list being associated with a candidate cell included in the subset of the candidate cells that is indicated by the received state list activation.

Aspect 15 is the method of any of aspects 1 to 14, further comprising: transmitting, for the network node, a capability indication that indicates at least one capability of the UE associated with the mobility of the UE, wherein the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

Aspect 16 is a method of wireless communication at a user equipment (UE), comprising: activating, prior to a switch from a serving cell to a target cell, at least one of a first transmission configuration indication (TCI) state list associated with a first cell configuration of the serving cell of the UE or a second TCI state list associated with a second cell configuration of the target cell for mobility of the UE; and maintaining, subsequent to the switch from the serving cell to the target cell and based on a state list indication, at least the second TCI state list as activated at the UE.

Aspect 17 is the method of aspect 16, wherein the state list indication is a set of state list conditions, wherein maintaining at least the second TCI state list as activated at the UE comprises: maintaining the first TCI state list as activated at the UE based on the set of state list conditions; or deactivating the first TCI state list at the UE based on the set of state list conditions.

Aspect 18 is the method of aspect 17, wherein the mobility of the UE for the target cell is Layer 1/Layer 2 (L1/L2) triggered mobility (LTM), wherein the UE replaces the first TCI state list based on its association with the LTM.

Aspect 19 is the method of aspect 17, wherein the UE supports a maximum number of concurrently active TCIs, wherein the maximum number of concurrently active TCIs corresponds to at least two concurrently active TCIs, and: wherein maintaining the first TCI state list as activated at the UE based on the set of state list conditions comprises maintaining the first TCI state list as activated at the UE for a duration of time subsequent to the switch from the serving cell to the target cell and based on the set of state list conditions; or wherein deactivating the first TCI state list at the UE based on the set of state list conditions comprises deactivating the first TCI state list at the UE based on the set of state list conditions indicating a deactivation of the first TCI state list at the UE when a total number of concurrently active TCIs at the UE is greater than the maximum number of concurrently active TCIs supported by the UE.

Aspect 20 is the method of aspect 19, further comprising: switching from the serving cell to the target cell; and switching back to the serving cell, utilizing the first TCI state list that is maintained as activated at the UE for the duration of time, based on a failure associated with the switching from the serving cell to the target cell.

Aspect 21 is the method of aspect 17, wherein the UE supports a single active TCI, and wherein the set of state list conditions indicates a deactivation of the first TCI state list at the UE based on the second TCI state list being activated.

Aspect 22 is the method of any of aspects 16 to 18, wherein the UE supports a maximum number of concurrently active TCIs, wherein the maximum number of concurrently active TCIs corresponds to at least two concurrently active TCIs; the method further comprising: receiving the second TCI state list and the first TCI state list at a different time occasion than the second TCI state list; and maintaining, subsequent to the switch from the serving cell to the target cell and based on the state list indication, the first TCI state list and the second TCI state list.

Aspect 23 is the method of aspect 22, wherein the state list indication is a set of state list conditions, maintained at the UE, which indicates maintenance of at most the maximum number of concurrently active TCIs that are most recently activated TCIs, wherein the first TCI state list and the second TCI state list are included in the most recently activated TCIs; or wherein maintaining the first TCI state list and the second TCI state list comprises: receiving, from a network node, the state list indication, and maintaining the first TCI state list and the second TCI state list based on the received state list indication.

Aspect 24 is the method of aspect 23, wherein maintaining the first TCI state list and the second TCI state list comprises replacing at least a third TCI state list that is active at the UE with at least one of the first TCI state list or the second TCI state list based on the third TCI state list having an activation time that is older than activation times of the most recently activated TCIs.

Aspect 25 is the method of any of aspects 16 to 18, wherein the UE supports a maximum number of concurrently active TCIs, wherein the maximum number of concurrently active TCIs corresponds to at least two concurrently active TCIs, and wherein a third TCI state list associated with the first cell configuration is received at the UE; the method further comprising: maintaining, based on the state list indication, the first TCI state list or the third TCI state list.

Aspect 26 is the method of aspect 25, wherein the state list indication is a set of state list conditions, maintained at the UE, which indicates maintenance of the maximum number of concurrently active TCIs associated with the serving cell that is based on a number of concurrently active TCIs associated with the target cell; wherein maintaining the first TCI state list or the third TCI state list comprises: receiving, from a network node, the state list indication; maintaining the first TCI state list or the third TCI state list based on the received state list indication; and deactivating another of first TCI state list and the third TCI state list based on the received state list indication.

Aspect 27 is the method of any of aspects 16 to 28, further comprising: transmitting, for a network node, a capability indication that indicates at least one capability of the UE associated with the mobility of the UE, wherein the at least one capability indicates support for at least one of: a maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

Aspect 28 is an apparatus for wireless communication including means for implementing any of aspects 1 to 15.

Aspect 29 is a computer-readable medium (e.g., a non-transitory computer-readable medium) storing computer executable code, the code when executed by at least one processor causes the at least one processor to implement any of aspects 1 to 15.

Aspect 30 is an apparatus for wireless communication at a network node. The apparatus includes a memory; and at least one processor coupled to the memory and, based at least in part on information stored in the memory, the at least one processor is configured to implement any of aspects 1 to 15.

Aspect 31 is the apparatus of aspect 30, further including at least one of a transceiver or an antenna coupled to the at least one processor.

Aspect 32 is an apparatus for wireless communication including means for implementing any of aspects 16 to 27.

Aspect 33 is a computer-readable medium (e.g., a non-transitory computer-readable medium) storing computer executable code, the code when executed by at least one processor causes the at least one processor to implement any of aspects 16 to 27.

Aspect 34 is an apparatus for wireless communication at a network node. The apparatus includes a memory; and at least one processor coupled to the memory and, based at least in part on information stored in the memory, the at least one processor is configured to implement any of aspects 16 to 27.

Aspect 35 is the apparatus of aspect 34, further including at least one of a transceiver or an antenna coupled to the at least one processor.

Aspect 36 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1 to 27.

Aspect 37 is an apparatus for wireless communication at a UE, comprising means for performing each step in the method of any of aspects 1 to 27.

Aspect 38 is the apparatus of any of aspects 36 and 37, further comprising a transceiver configured to receive or to transmit in association with the method of any of aspects 1 to 27.

Aspect 39 is a computer-readable medium storing computer executable code at a UE, the code when executed by at least one processor causes the at least one processor to perform the method of any of aspects 1 to 27.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a second transmission configuration indication (TCI) state list associated with mobility of the UE for a target cell; and
activate, subsequent to a switch from a serving cell to the target cell and based on a state list indication, at least one of a first TCI state list associated with a cell configuration of the target cell at the UE or the second TCI state list.

2. The apparatus of claim 1, wherein the state list indication is a set of state list conditions, wherein to activate at least one of the first TCI state list or the second TCI state list, the at least one processor, individually or in any combination, is configured to:
activate the first TCI state list and the second TCI state list simultaneously based on the set of state list conditions.

3. The apparatus of claim 2, wherein the first TCI state list and the second TCI state list comprise a same TCI identifier (ID) pool and have different TCI ID subsets of the TCI ID pool; or
wherein the first TCI state list is a subset of the second TCI state list.

4. The apparatus of claim 1, wherein the state list indication is a set of state list conditions, wherein to activate at least one of the first TCI state list or the second TCI state list, the at least one processor, individually or in any combination, is configured to:
activate the second TCI state list by replacing the first TCI state list.

5. The apparatus of claim 4, wherein the mobility of the UE for the target cell is Layer 1/Layer 2 (L1/L2) triggered mobility (LTM), wherein the UE replaces the first TCI state list based on its association with the LTM.

6. The apparatus of claim 1, wherein the second TCI state list is present at the UE prior to receiving the first TCI state list.

7. The apparatus of claim 1, wherein the UE supports a maximum number of concurrently active TCIs, wherein the maximum number of concurrently active TCIs corresponds to at least two concurrently active TCIs, and wherein receiving the second TCI state list comprises receiving the first TCI state list at a different time occasion than the second TCI state list;
wherein the at least one processor, individually or in any combination, is further configured to:
maintain, subsequent to the switch from the serving cell to the target cell and based on the state list indication, the first TCI state list and the second TCI state list.

8. The apparatus of claim 7, wherein the state list indication is a set of state list conditions, maintained at the UE, which indicates maintenance of at most the maximum number of concurrently active TCIs that are most recently activated TCIs, wherein the first TCI state list and the second TCI state list are included in the most recently activated TCIs; or
wherein to maintain the first TCI state list and the second TCI state list, the at least one processor, individually or in any combination, is configured to:
receive, from the network node, the state list indication, and
maintain the first TCI state list and the second TCI state list based on the received state list indication.

9. The apparatus of claim 8, wherein to maintain the first TCI state list and the second TCI state list, the at least one processor, individually or in any combination, is configured to replace at least a third TCI state list that is active at the UE with at least one of the first TCI state list or the second TCI state list based on the third TCI state list having an activation time that is older than activation times of the most recently activated TCIs.

10. The apparatus of claim 1, wherein the UE supports a maximum number of concurrently active TCIs for a set of candidate cells, wherein the UE is configured to maintain a target number of concurrently active TCIs for the target cell, wherein the target cell is included in the set of candidate cells, and wherein to receive the second TCI state list, the at least one processor, individually or in any combination, is configured to receive a third TCI state list associated with a candidate cell configuration that is separate from the cell configuration of the target cell;
wherein the at least one processor, individually or in any combination, is further configured to:
maintain or deactivate, subsequent to the switch from the serving cell to the target cell and based on the state list indication, the third TCI state list.

11. The apparatus of claim 10, wherein the state list indication is a set of state list conditions that indicates a set of lowest TCI identifiers (IDs), and wherein to maintain or deactivate the third TCI state list, the at least one processor, individually or in any combination, is configured to:
maintain or deactivate the third TCI state list based on TCIs associated with the third TCI state list having TCI IDs in the set of lowest TCI IDs.

12. The apparatus of claim 10, wherein the state list indication indicates a separate TCI activation for the third TCI state list, wherein to maintain or deactivate the third TCI state list, the at least one processor, individually or in any combination, is configured to:
receive, from the network node, the state list indication; and
maintain or deactivate the third TCI state list based on the received state list activation.

13. The apparatus of claim 10, wherein the state list indication is a set of state list conditions that indicates maintenance of the target number of concurrently active TCIs for the target cell and deactivation for a remaining portion of active TCIs associated with the set of candidate cells, and wherein to maintain or deactivate the third TCI state list, the at least one processor, individually or in any combination, is configured to:
maintain or deactivate the third TCI state list based on the set of state list conditions.

14. The apparatus of claim 10, wherein the state list indication indicates a subset of the candidate cells, wherein to maintain or deactivate the third TCI state list, the at least one processor, individually or in any combination, is configured to:
receive, from the network node, the state list indication; and
maintain or deactivate the third TCI state list based on the third TCI state list being associated with a candidate cell included in the subset of the candidate cells that is indicated by the received state list activation.

15. The apparatus of claim 1, wherein the at least one processor, individually or in any combination, is further configured to:
transmit, for the network node, a capability indication that indicates at least one capability of the UE associated with the mobility of the UE, wherein the at least one capability indicates support for at least one of: a first maximum number of concurrently active TCIs, a second maximum number of concurrently active TCIs for a set of candidate cells, a single active TCI, a maintenance of a TCI after a cell switch, a first TCI activation prior to a switching command, or a second TCI activation concurrent with the switching command.

16. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
activate, prior to a switch from a serving cell to a target cell, at least one of a first transmission configuration indication (TCI) state list associated with a first cell configuration of the serving cell of the UE or a second TCI state list associated with a second cell configuration of the target cell for mobility of the UE; and
maintain, subsequent to the switch from the serving cell to the target cell and based on a state list indication, at least the second TCI state list as activated at the UE.

17. The apparatus of claim 16, wherein the state list indication is a set of state list conditions, wherein to maintain at least the second TCI state list as activated at the UE, the at least one processor, individually or in any combination, is configured to:
maintain the first TCI state list as activated at the UE based on the set of state list conditions; or
deactivate the first TCI state list at the UE based on the set of state list conditions.

18. The apparatus of claim 17, wherein the mobility of the UE for the target cell is Layer 1/Layer 2 (L1/L2) triggered mobility (LTM), wherein the UE replaces the first TCI state list based on its association with the LTM.

19. The apparatus of claim 17, wherein the UE supports a maximum number of concurrently active TCIs, wherein the maximum number of concurrently active TCIs corresponds to at least two concurrently active TCIs, and:
wherein to maintain the first TCI state list as activated at the UE based on the set of state list conditions, the at least one processor, individually or in any combination, is configured to maintain the first TCI state list as activated at the UE for a duration of time subsequent to the switch from the serving cell to the target cell and based on the set of state list conditions; or
wherein to deactivate the first TCI state list at the UE based on the set of state list conditions, the at least one processor, individually or in any combination, is configured to deactivate the first TCI state list at the UE based on the set of state list conditions indicating a deactivation of the first TCI state list at the UE when a total number of concurrently active TCIs at the UE is greater than the maximum number of concurrently active TCIs supported by the UE.

20-27. (canceled)

28. A method of wireless communication at a user equipment (UE), comprising:
receiving, from a network node, a second transmission configuration indication (TCI) state list associated with mobility of the UE for a target cell; and
activating, subsequent to a switch from a serving cell to the target cell and based on a state list indication, at least one of a first TCI state list associated with a cell configuration of the target cell at the UE or the second TCI state list.

29-30. (canceled)
